(19) United States
(12) Patent Application Publication
(10) Pub. No.: US 2020/0076223 A1
(43) Pub. Date: Mar. 5, 2020

(54) CHARGING CONTROL SYSTEM AND CHARGING CONTROL DEVICE

(71) Applicant: SEMICONDUCTOR ENERGY LABORATORY CO., LTD., Atsugi-shi, Kanagawa-ken (JP)

(72) Inventors: Kazutaka KURIKI, Ebina, Kanagawa (JP); Ryota TAJIMA, Isehara, Kanagawa (JP); Hideaki SHISHIDO, Atsugi, Kanagawa (JP); Yusuke YOSHITANI, Isehara, Kanagawa (JP); Haruki KATAGIRI, Atsugi, Kanagawa (JP); Yohei MOMMA, Isehara, Kanagawa (JP)

(21) Appl. No.: 16/610,931

(22) PCT Filed: May 11, 2018
(86) PCT No.: PCT/IB2018/053273

§ 371 Date: Nov. 5, 2019

(30) Foreign Application Priority Data
May 22, 2017 (JP) 2017-100976

(51) Int. Cl. H02J 7/04; H02J 7/02; H02J 7/00; H02J 50/20; H02J 50/80; B60L 53/12; B60L 50/60; B60L 53/62; G05B 13/02; H01M 10/46; H01M 10/44

(52) U.S. Cl. CPC H02J 7/04; H02J 7/025; H02J 7/0021; H02J 50/20; H02J 50/80; H01M 2220/20; B60L 50/66; B60L 53/62; G05B 13/027; H01M 10/46; H01M 10/44; B60L 53/12

(57) ABSTRACT

A charging control device using machine learning is provided. A high-security charging control device is provided. A charging control system with little deterioration is provided. A storage battery having excellent characteristics is provided.

An approximate charging end time is calculated. A result obtained when it is different from the estimated charging end time is fed back and learned, and accordingly the charging end can be precisely estimated after the next time. That is, the portable information terminal makes a charging plan with the use of artificial intelligence and the secondary battery is charged based on information about the charging plan. The charging plan is made to reduce the retention time of the full charging (SOC 100%) and charging is executed. Charging history information is stored in the portable information terminal and made use of to make the next charging plan.

### TECHNICAL FIELD

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof. In particular, one embodiment of the present invention relates to a charging control device, a charging control system, and an electronic device including a secondary battery.

In this specification, the power storage device is a collective term describing units and devices having a power storage function. For example, the power storage device includes a storage battery (also referred to as secondary battery) such as a lithium-ion secondary battery, a lithium-ion capacitor, a nickel hydrogen battery, an all-solid battery, an electric double layer capacitor, and the like.

One embodiment of the present invention relates to a neural network and a charging control device using the neural network. One embodiment of the present invention relates to vehicle using a neural network. One embodiment of the present invention relates to an electronic device using a neural network. One embodiment of the present invention is not limited to a vehicle, and can also be applied to a charging control system of a power storage device for storing electric power obtained from power generation facilities such as a solar power generation panel provided in a structure body or the like.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, tablets, and laptop computers, portable music players, digital cameras, medical equipment, next-generation clean energy vehicles such as hybrid electric vehicles (HEV), electric vehicles (EV), and plug-in hybrid electric vehicles (PHEV), and the like, and the lithium-ion secondary batteries are essential as rechargeable energy supply sources for today's information society.

In a portable information terminal, an electric vehicle, or the like, a power storage device is used as a battery pack (also referred to as an assembled battery) in which a plurality of secondary batteries are connected in series or in parallel and a protective circuit is provided.

The plurality of secondary batteries contained in the battery pack have individual differences even though they are manufactured through the same process. Even when batteries having uniform characteristics right after manufacture are used, repeated charging and discharging also cause individual differences in deterioration for some reasons. Consequently, terminal voltages of the plurality of secondary batteries are not uniform during charging, which causes an unbalance; an overcharged secondary battery, a secondary battery that is not charged to full charging, and the like are generated.

As a result, the capacity of the whole battery pack decreases, and deterioration of some of the secondary batteries is accelerated. An increase of the imbalance might rapidly reduce lifetime. The degree of deterioration changes depending on the timing when a user charges or discharges an electronic device including the battery pack, and accordingly, even if the secondary batteries are inspected when manufactured, the secondary battery that might cause abnormality is difficult to select. In particular, when fast charging is performed, a stress is applied to a material inside the secondary battery by charging with high current and high voltage, or the secondary battery gets to full charging in a short time to spend a longer time in a full charging state, whereby deterioration of the secondary battery is likely to proceed.

Patent Document 1 discloses a battery module including a transistor using an oxide semiconductor and a processor, which control the function of preventing overcharging or the like.

### PRIOR ART DOCUMENT

### Patent Document

### Patent Document 1

Japanese Published Patent Application No. 2014-135884

### SUMMARY OF THE INVENTION

### Problems to be Solved by the Invention

An object to extend the lifetime of a storage battery in an electronic device including the storage battery typified by a lithium-ion secondary battery. An object is to provide a novel charging control device, a novel charging control method, a novel program, and a novel charging control system.

Note that the descriptions of these objects do not preclude the existence of other objects. One embodiment of the present invention does not need to achieve all the objects. Other objects can be derived from the description of the specification, the drawings, and the claims.

### Means for Solving the Problems

A structure disclosed in this specification is a charging control system comprising a battery portion storing a secondary battery, a charging and discharging management portion determining a charging plan by neural network computation to reduce a full charging retention time on the basis of the charging plan when the time of connection to an external power source is longer than the estimated charging time for the secondary battery, and a charging portion comprising a charging retention portion. At least one of factors used for the neural network computation is a remaining capacity of the secondary battery. Note that the neural network is a kind of machine learning and is also called deep learning. Deep learning is also called artificial intelligence.

On the basis of battery information (remaining capacity, deterioration information, or the like) of the secondary battery incorporated in an electronic device and schedule information about the use of the electronic device by a user, artificial intelligence (AI) incorporated in the electronic device estimates the degree of future deterioration and selects and executes the most suitable charging method (including conditions of the timing, the voltage value, the current value, and the like of charging). Artificial intelligence refers to software or a system in which an intelligent work conducted by the human brain is imitated by a computer, and is a computer program capable of logical inferences or learning from experiences.

Specifically, various kinds of data are evaluated and learned using machine leaning, and the charging conditions suited to the estimated degree of deterioration are determined. For example, charging and discharging characteristics of a secondary battery for learning which are measured immediately after manufacture are evaluated and learned, and the degree of deterioration of a target secondary battery is estimated. Then, the estimated charging time of the secondary battery can be calculated in consideration of the remaining capacity.

A reduction in full charging retention time can reduce deterioration of the secondary battery FIG. 5 shows cycle characteristics of secondary battery cells with full charging retention times of 1 minute, 10 minutes, and 30 minutes. It is found from FIG. 5 that the cycle characteristics are more favorable when the full charging retention time is the shorter. Therefore, the charging control system with a reduced full charging retention time is provided. For example, in a method of controlling charging, charging is stopped late at night when the remaining capacity reaches approximately seventy percent of the full charging and the full charging state is obtained only just before a user goes out carrying the electronic device early in the morning.

In a portable information terminal, since a small secondary battery is used, the capacity is low and the charging frequency is high. When charging is performed with a conventional charger, an end of charging leads the remaining capacity to the full charging state, and the full charging state is retained for a long time of the day until a user goes out carrying the electronic device as long as the electronic device is not detached from the charger; thus the secondary battery might extremely deteriorate.

A charging method proposed by artificial intelligence on the basis of factors such as schedule information and a desired stop time of the charging end written to a memory of a portable information terminal by a user is selected and executed. The secondary battery may be charged with a wire or wirelessly. In the case of charging with a wire, charging conditions (the maximum voltage value and the maximum current value) are limited by the kind of a cable. Since the cable is provided with an IC chip for the charging conditions, the IC chip is read and the limitations on the charging conditions for the use of the cable are learned by artificial intelligence. In the case of wireless charging, power supply can be stopped by stopping a radio signal, and power supply can be resumed by resuming transmission of a radio signal. Also in the case of wireless charging, charging conditions (the maximum voltage value and the maximum current value) are limited by the kind of an antenna.

Possibilities for the charging conditions are given by machine learning on the basis of some factors (a schedule, temperature, remaining capacity, and the like), and the charging method is determined by a user as appropriate. Alternatively, a microprocessor may be set to automatically determine and execute the most suitable charging conditions without depending on a user. The microprocessor, a memory, and a peripheral chip can form a microcontroller. Algorithm is installed in the microprocessor. As algorithm, an artificial neural network (simply referred to as a neural network), a bayesian network, a hidden Markov model, a Bayes classifier, a decision tree, a support vector machine, or the like can be used. As a neural network, a tool installed in Python (registered trademark) or Matlab (registered trademark) is used.

In this specification, a neural network refers to a general model that is modeled on a biological neural network, determines the connection strength of neurons by learning, and has the capability of solving problems. A neural network includes an input layer, an intermediate layer (also referred to as a hidden layer), and an output layer.

In describing a neural network in this specification, to determine a connection strength of neurons (also referred to as a weight coefficient) from existing information is sometimes referred to as learning.

Moreover, in this specification, to draw a new conclusion from a neural network formed using connection strengths obtained by learning is sometimes referred to as inference.

Neural network computation is executed by a huge number of computations using a microprocessor. In the case where the arithmetic processing is performed by a digital circuit, a huge number of transistors are needed in some cases. Thus, the above operations are preferably performed by an analog product-sum operation circuit (hereinafter referred to as APS (Analog Product-Sum circuit)). The APS preferably includes an analog memory. The APS stores a weight coefficient obtained by learning, in the analog memory, whereby the APS can perform the product-sum operations using analog data as it is. Consequently, the APS enables a neural network to be formed efficiently with a small number of transistors.

Note that, in this specification, an analog memory refers to a memory device that can store analog data. In addition, analog data refers to data having a resolution of three bits (eight levels) or more in this specification. Multilevel data is referred to as analog data in some cases.

As the analog memory, a multilevel flash memory, a ReRAM (Resistive Random Access Memory), an MRAM (Magnetoresistive Random Access Memory), or a memory using an OS transistor (hereinafter. OS memory) can be used.

In this specification and the like, a transistor including an oxide semiconductor or a metal oxide in its channel formation region is referred to as an oxide semiconductor transistor or an OS transistor. The channel formation region of an OS transistor preferably includes a metal oxide.

In this specification and the like, a metal oxide means an oxide of metal in a broad sense. Metal oxides are classified into an oxide insulator, an oxide conductor (including a transparent oxide conductor), an oxide semiconductor (also simply referred to as an OS), and the like. For example, a metal oxide used in a semiconductor layer of a transistor is referred to as an oxide semiconductor in some cases. That is to say, in the case where a metal oxide has at least one of an amplifying function, a rectifying function, and a switching function, the metal oxide can be called a metal oxide semiconductor or OS for short.

The metal oxide included in the channel formation region preferably contains indium (in). When the metal oxide included in the channel formation region is a metal oxide containing indium, the carrier mobility (electron mobility) of the OS transistor increases. The metal oxide included in the channel formation region is preferably an oxide semiconductor containing an element M. The element M is preferably aluminum (Al), gallium (Ga), tin (Sn), or the like. Other elements that can be used as the element NI are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a plurality of the above-described elements is combined as the element M in some cases. The element M is an element having high bonding energy with oxygen, for example. The element M is an element having higher bonding energy with oxygen than indium, for example. The metal oxide included in the channel formation region is preferably a metal oxide containing zinc (Zn). A metal oxide containing zinc is easily crystallized in some cases.

The metal oxide included in the channel formation region is not limited to a metal oxide containing indium. The semiconductor layer may be a metal oxide that does not contain indium and contains zinc, a metal oxide that contains gallium, or a metal oxide that contains tin; for example, a zinc tin oxide or a gallium tin oxide.

In the above structure, the charging portion is connected to the external power source through a wire, or the charging portion includes an antenna and performs charging and discharging with the external power source wirelessly.

In the above structure, the battery portion may be provided in a vehicle or may be provided in a portable information terminal. In the case of the provision in a vehicle, a plurality of secondary batteries are used and thus may be each individually provided with the above charging control system. A plurality of secondary batteries may be provided as one group with one charging control system described above, and a plurality of groups may be provided in the vehicle.

A circuit (microprocessor) which performs neural network computation may be provided in a vehicle or may be provided in a portable information terminal. In the neural network computation, communication with a computer may be performed and data stored in the computer may be used. When the communication with a computer is performed and the data stored in the computer is used to perform the neural network computation, the neural network computation can be performed using a huge amount of data.

In the above structure, the charging and discharging management portion may be provided in a portable information terminal or may be provided in a power feeding device. The power feeding device includes a function of communication with the computer and the circuit (microprocessor) performing neural network computation.

A charging control device is also one of the present invention. The charging control device includes a power feeding device, a charging and discharging control circuit electrically connected to the power feeding device, a microprocessor capable of performing at least neural network computation, and a communication means instructing or stopping transmission from the power feeding device.

In the above structure, the power feeding device includes a first antenna. The communication means instructs or stops transmission from the power feeding device to a second antenna overlapping with the first antenna. The second antenna is electrically connected to the secondary battery.

In the above structure, the power feeding device includes a memory portion electrically connected to the microprocessor. The memory portion can store data for learning, a program, a charging history, and the like.

### Effect of the Invention

According to one embodiment of the present invention, a novel charging control device utilizing machine learning is provided. Alternatively, according to one embodiment of the present invention, a high-security charging control system is provided. Alternatively, according to one embodiment of the present invention, a charging control system with little deterioration is provided.

### BRIEF DESCRIPTION OF THE DRAWINGS

FIG. 1 A perspective view and a block diagram of a portable information terminal showing one embodiment of the present invention.

FIG. 2 A flow chart showing one embodiment of the present invention.

FIG. 3 A perspective view and a cross-sectional view of a portable information terminal put on a power feeding device showing one embodiment of the present invention.

FIG. 4 A flow chart showing one embodiment of the present invention.

FIG. 5 A graph showing full charging retention time and cycle characteristics,

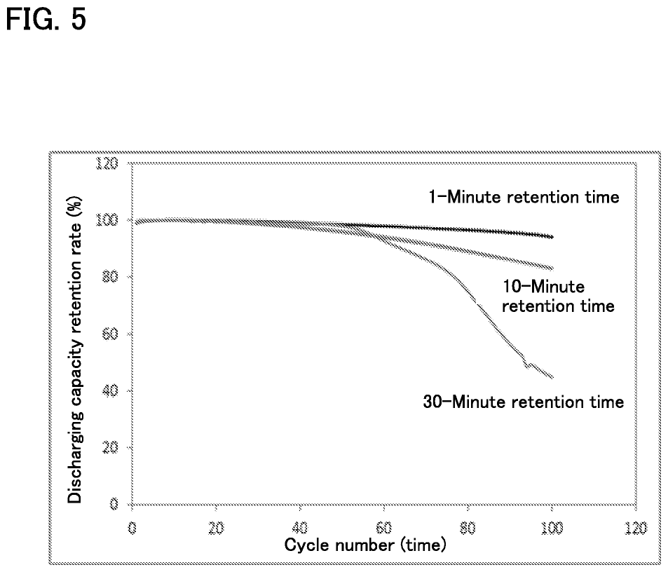

FIG. 6 A diagram showing a configuration of a neural network.

FIG. 7 Diagrams showing a configuration of a neural network.

FIG. 8 Diagrams showing configurations of a neural network.

FIG. 9 A block diagram showing a configuration example of a product-sum arithmetic circuit,

FIG. 10 A circuit diagram showing a configuration example of a circuit.

FIG. 11 A timing chart showing an operation example of a product-sum arithmetic circuit.

FIG. 12 Diagrams illustrating a cylindrical secondary battery.

FIG. 13 Diagrams illustrating a secondary battery.

FIG. 14 Diagrams illustrating a secondary battery.

FIG. 15 Diagrams illustrating a secondary battery.

FIG. 16 A diagram illustrating a secondary battery.

FIG. 17 Diagrams illustrating an example of an electronic device.

FIG. 18 A diagram illustrating examples of electronic devices.

FIG. 19 Diagrams illustrating examples of electronic devices.

FIG. 20 Diagrams illustrating an example of an electronic device.

### MODE FOR CARRYING OUT THE INVENTION

Hereinafter, embodiments of the present invention will be described in detail with reference to drawings. Note that the present invention is not limited to the description below, and it is easily understood by those skilled in the art that modes and details of the present invention can be modified in various ways. In addition, the present invention should not be construed as being limited to the description in the embodiments given below.

### Embodiment 1

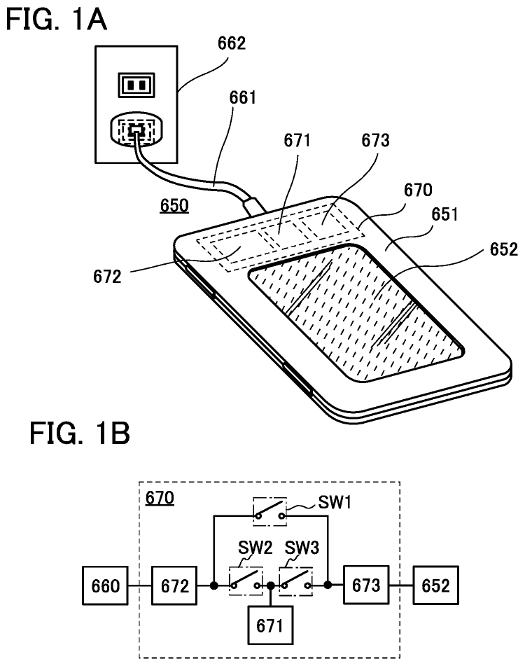

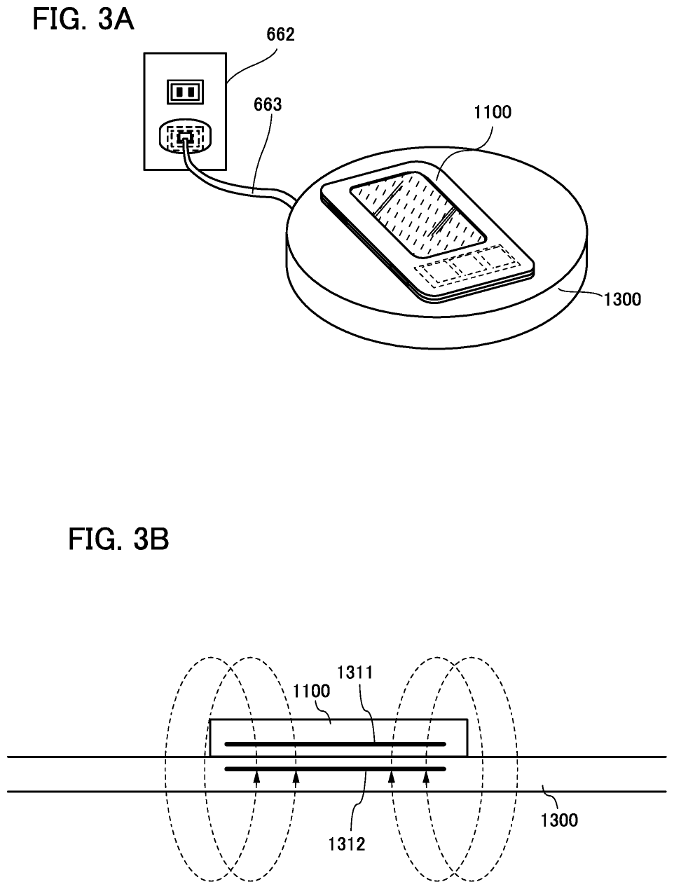

As illustrated in FIG. 1(A), a portable information terminal 650 is connected to an external power source 662 through a cable 661. The cable 661 corresponds to a USB cable or the like and can be detached from the portable information terminal 650. The portable information terminal 650 may be connected not to the external power source illustrated in FIG. 1(A) but to a cable connected to a personal computer. As illustrated in FIG. 3(A), a contactless charging method may be used.

The portable information terminal 650 illustrated in FIG. 1(A) includes a housing 651, a display portion 652, a power switch, an optical sensor, a camera lens, a speaker, a microphone, and a power source.

The display portion 652 is a touch panel, and keyboard buttons for inputting text can be displayed as needed. When the keyboard button is touched with a finger, a stylus, or the like, text can be input. Furthermore, when text is directly written or an illustration is directly drawn in the display portion 652 with a finger, a stylus, or the like without displaying the keyboard buttons, the text or the illustration can be displayed on the display portion 652.

Functions which can be performed with the portable information terminal 650 are displayed on the display portion 652. When a marker indicating a desired function is touched with a finger, a stylus, or the like, the portable information terminal 650 executes the function. For example, when a marker is touched, the function as a phone becomes operative and thus a phone conversation can be carried out with the speaker and the microphone.

The portable information terminal 650 is equipped with a sensing device which senses inclination, such as a gyroscope or an acceleration sensor (not illustrated). Thus, when the housing 651 is placed horizontally or vertically, the display orientation can be changed to vertical display, horizontal display, or the like in the display portion 652.

The portable information terminal 650 is provided with the optical sensor; thus, in the portable information terminal 650, the brightness of the display portion 652 can be optimally controlled in accordance with the amount of ambient light detected with the optical sensor.

The portable information terminal 650 is provided with the power source, and the power source includes a solar cell 660 and a charging and discharging control circuit 670. Note that FIG. 1(B) illustrates a structure including a battery 671, a DC-DC converter 672, a converter 673, and switches SW1 to SW3 as an example of the charging and discharging control circuit 670, and the battery 671 is a lithium-ion secondary battery. The battery is not limited to a lithium-ion secondary battery. As a positive electrode material of the secondary battery, for example, a material including an element A, an element X, and oxygen can be used. The element A is preferably one or more selected from the Group 1 elements and the Group 2 elements. As a Group 1 element, for example, an alkali metal such as lithium, sodium, or potassium can be used. As a Group 2 element, for example, calcium, beryllium, magnesium, or the like can be used. As the element X, for example, one or more selected from metal elements, silicon, and phosphorus can be used. The element X is preferably one or more selected from cobalt, nickel, manganese, iron, and vanadium. Typical examples include lithium-cobalt composite oxide (LiCoO₂) and lithium iron phosphate (LiFePO₄).

The portable information terminal 650 can also have a function of displaying various kinds of information (a still image, a moving image, a text image, and the like), a function of displaying a calendar, a date, the time, or the like on the display portion, a touch-input function of operating or editing data displayed on the display portion by touch input, a function of controlling processing by various kinds of software (programs), and the like.

When the portable information terminal 650 is connected to the external power source 662 through the cable 661, the mode switches to a mode of using the external power source 662 as the main power source after a predetermined time elapses. Regardless of whether the portable information terminal 650 is in an on state or in an off state, this mode switching is made. Note that the cable 661 refers to a USB (Universal Serial Bus) cable, a micro USB, or the like which can transmit data information or supply electric power.

In this embodiment, a feature is that a lithium-ion secondary battery is used and charging is performed after a charging plan is made to reduce a full charging retention time.

It takes much time to charge a high-capacity lithium-ion secondary battery. In the case where charging is performed sequentially in three phases, for example, where a precharge phase is transferred to a constant current (CC) charging phase at a SOC (State Of Charge) of 30% and the constant current charging phase is transferred to a constant voltage (CV) charging phase at a SOC of 80%, the time taken to the end of charging (the amount of time between the charging end time and the charging start time) is difficult to estimate. Fast charging is possible for a time reduction but increases the full charging retention time. In addition, if the charging voltage is increased for fast charging, the lithium-ion secondary battery might deteriorate or be damaged. Conventionally, keeping the lifecycle of connecting a portable information terminal to an external power source through a cable to be charged at night and this connection through the cable continues until morning reduces the lifetime of the lithium-ion secondary battery.

With the charging control system of this embodiment, charging is stopped before full charging (SOC 100%), specifically, when the SOC is higher than or equal to 50% and lower than 80%, and then charging is resumed such that full charging (SOC 100%) is achieved at departure time.

First, when a portable information terminal is connected to an external power source through a cable, a CPU and an IC for charging control are started to analyze the state of a secondary battery. The phase to be executed varies depending on the remaining capacity of the secondary battery. When there is little remaining capacity of the secondary battery, charging is started from the precharge phase. When there is a high remaining capacity of the secondary battery, only the constant voltage charging phase is executed. The remaining capacity of the secondary battery is sometimes represented by SOC. The SOC is also called a charging rate and defined as the proportion of remaining capacity to the capacity available for charging of a secondary battery. For a secondary battery, since deterioration due to use leads to a decrease of the capacity available for charging and discharging, the healthiness (State Of Health (SOH)) is defined as the proportion of capacity available for charging at the time of deterioration after an elapse of time to the capacity available for charging at the initial use of the battery (=100%). Therefore, the remaining capacity is expressed more precisely when SOC (%) is multiplied by SOH (%)/100 but is expressed as SOC for simpler explanation. A full charging state can be called SOC 100%. When the time in the SOC 100% state is long, decomposition of an electrolytic solution used in a secondary battery or the like occurs and promotes deterioration. Thus, a reduction in time in the SOC 100% state leads to an extension of the lifetime of the secondary battery.

Then, an approximate charging end time is calculated using artificial intelligence on the basis of information about a past charging history stored in a memory portion such as a memory. A result obtained when it is different from the estimated charging end time is learned, and accordingly the charging end can be precisely estimated after the next time. That is, the portable information terminal makes a charging plan with the use of artificial intelligence and the secondary battery is charged based on information about the charging plan.

Full charging is achieved by one charging from the start of electrical connection to the external power source; and planned charging including a retention time (i.e., a charging stop period) in one charging is performed. Therefore, the portable information terminal preferably includes a timer function or a radio-controlled clock or includes a communication means which acquires time information using a network or the like, a communication means which acquires time information from a surrounding electronic device (including a radio-controlled clock), or the like. The charging plan is made based on such time information to reduce the retention time of full charging (SOC 100%) and charging is executed. Information about a charging history stored in a memory included in the portable information terminal is further made use of to make the next charging plan.

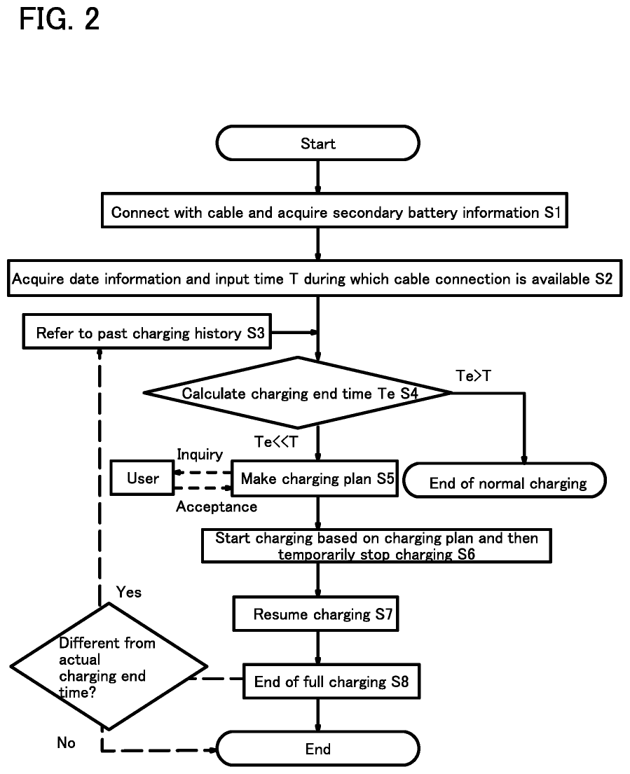

Here, a charging operation of the charging control system in this embodiment is described using drawings. FIG. 2 is a flow chart illustrating the operation. Note that an example in which a microprocessor capable of neural network computation is included in the portable information terminal is shown. The microprocessor incorporated in the portable information terminal includes an analog product-sum arithmetic circuit. The details of the analog product-sum arithmetic circuit are described in a later embodiment.

First, the external power source and the portable information terminal are electrically connected using a cable for charging, and the microprocessor automatically acquires information about the remaining capacity (SOC) of the secondary battery (S1). As methods of calculating the remaining capacity of the secondary battery, there are a detection method by a voltage method, a detection method by an integration method, and the like. Models depending on valuables such as current, voltage, internal temperature, no-load voltage, external temperature, and impedance relate to the detection of the SOC based on physical models. The method of detecting the SOC is coulometry.

Next, date and time information is acquired and a time T during which the cable connection is available is input (S2). The date and time information is acquired by the clock, the radio-controlled clock, or the like incorporated in the portable information terminal. The time T during which the cable connection is available may be automatically calculated from a schedule which a user input to the portable information terminal, or the like; in the case where charging is performed at home, a user may input the home departure time. In other words, the time T during which the cable connection is available is a period from a start of the cable connection to an interruption of the electrical connection to the external power source.

Next, if the past charging history is stored in the memory or the like, the microprocessor performs neural network computation with reference to the past charging history (S3) and calculates a charging end time Te (a time that can be calculated from the estimated charging time) (S4). The remaining capacity (SOC), the extent of deterioration, the number of times of charging, or the like is used as a factor of the neural network computation.

If the calculated charging end time Te is later than the time T during which the cable connection is available, normal charging is performed and ended before full charging is reached. Alternatively, fast charging is performed in the case where a user desires to increase the SOC within a limited time. Examples of a method of fast charging are a step control charging method, a −ΔV control charging method, a dT/dT control charging method, and the like.

If the calculated charging end time Te is earlier than the time T during which the cable connection is available, the microprocessor makes a charging plan (S5). The microprocessor computes the history of daily capacity use by the user and the used capacity at every day of the week. Alternatively, information such as a schedule that can be read from information from the user's mail or comments on a weblog is employed, and the home departure time, the riding time of a train used for commutation, GPS positional information, or a use history of the user's contactless IC card is used as a factor in making the charging plan. The charging plan may be automatically made in consideration of the possibility of an increase in electric power usage from an application in use, a download plan, a family event, a game event, or the like. Information about a deterioration curve of the battery or the like can also be taken into consideration to make the charging plan, which can also lead to the most suitable SOC.

In an example of the charging plan, charging is performed until the SOC becomes 50% and, after a period of time, recharging is performed so that the SOC becomes 100% immediately before a cable disconnection time. Although this charging plan may be automatically executed when completed, a process of contacting the user and receiving approval may be interposed. The microprocessor may make and propose a plurality of charging plans to the user so that the user can make a selection from them.

Then, charging is started by the microprocessor in accordance with the charging plan, and then temporarily stopped by a charging retention portion (S6). At the time of the temporal stop, the full charging state is not reached. The period and timing for the temporal stop is determined by the microprocessor.

Next, charging is resumed in accordance with the time when the full charging is to be reached (S7). Then, charging is again stopped when the full charging (SOC 100%) is reached; thus the full charging is ended (S8). The microprocessor determines whether there is an error to confirm whether the charging end time Te when the full charging (SOC 100%) is actually reached corresponds to the charging end time Te calculated in the previous step (S4), and additionally stores a new charging history as a past charging history. It can be fed back to the next charging, and accordingly the charging end time Te can be more accurately calculated. Thus, the retention time of the full charging (SOC 100%) can be reduced. Note that a designer determines the allowable range of the SOC use for an actual device. For example, device specifications in which the allowable range of the SOC use is higher than or equal to 20% and lower than or equal to 80% and electric power from the secondary battery is interrupted when the SOC is lower than 20% while charging is stopped when the SOC is higher than or equal to 80% are set in some cases. In such a device, a state of SOC 80% can be regarded as full charging.

Of course, this embodiment is not limited to the order shown in the flow chart. For example, the order of the step 1 (S1) and the step 2 (S2) may be reversed or the steps may be simultaneously performed. The step 3 (S3) may be performed before the step 1 (S1).

Furthermore, a protective circuit may be provided in the secondary battery. The protective circuit has a function of protection from overcharge, a function of protection from overdischarge, and a function of protection from overcurrent. The protective circuit is preferably controlled with the use of the microprocessor.

Although an example in which one secondary battery is included in the portable information terminal is described in this embodiment, there is no particular limitation. This embodiment can also be applied in the case where a plurality of secondary batteries are included in a vehicle.

Although an example in which connection is made to the power source through the cable and an outlet plug as the external power source is described, there is no particular limitation. This embodiment can be applied also when a storage battery (including a primary battery) employing another method or an auxiliary battery such as a mobile battery is used instead of the external power source.

### Embodiment 2

In Embodiment 1, an example in which the portable information terminal is connected to the external power source through a wire, that is, through the cable for charging during charging is described. In this embodiment, an example in which wireless charging is performed using a power feeding device 1300, which is a kind of electronic device, is described. FIG. 3(B) is a cross-sectional view of a portable information terminal. For example, in the case of an electromagnetic induction method, as shown in FIG. 3(B), an antenna 1311 provided for a portable information terminal 1100 and an antenna 1312 provided for the power feeding device 1300 are electromagnetically coupled to form a power transmission transformer, whereby power can be supplied to the portable information terminal 1100. The antenna 1312 is electrically connected to an external power source 662 through a cable 663. Note that the cable 663 can be detached from the power feeding device 1300.

Although FIG. 3(A) and FIG. 3(B) illustrate an example in which the portable information terminal 1100 overlaps with the power feeding device 1300, which is a kind of electronic device, a battery pack may be detached from the portable information terminal 1100 so that the antenna of the battery pack may overlap with the power feeding device 1300) in the case where the battery pack can be detached from the portable information terminal 1100.

There is no particular limitation on the structure of the power feeding device 1300. For example, a moving coil method in which the position of the portable information terminal 1100 is detected and the antenna 1312 is moved so as to overlap with the portable information terminal 1100, whereby charging is performed, a multi-coil method in which a plurality of antennas 1312 are provided and charging is performed with the antenna 1312 that overlaps with the portable information terminal 1100, or the like may be employed. In addition, the power feeding device 1300, which is a kind of electronic device, may be equipped with a microprocessor capable of performing neural network computation, and in that case, the power feeding device 1300 can also be called a charging control device. In this case, the charging control device includes the power feeding device, a charging and discharging control circuit electrically connected to the power feeding device, the microprocessor capable of performing at least neural network computation, and a communication means that stops transmission from the power feeding device. The microprocessor is formed of a digital circuit or an analog circuit. In this embodiment, neural network computation is performed using a microcontroller including a digital circuit using silicon.

An electric device which can be charged by the power feeding device 1300 is not limited to the above. For example, application is possible for an electric vehicle. Application is possible in one or both of the case in which an electric vehicle is charged by being electrically connected to a power feeding facility and the case in which an electric vehicle is charged after regenerative energy utilizing a brake or the like is converted into electric power.

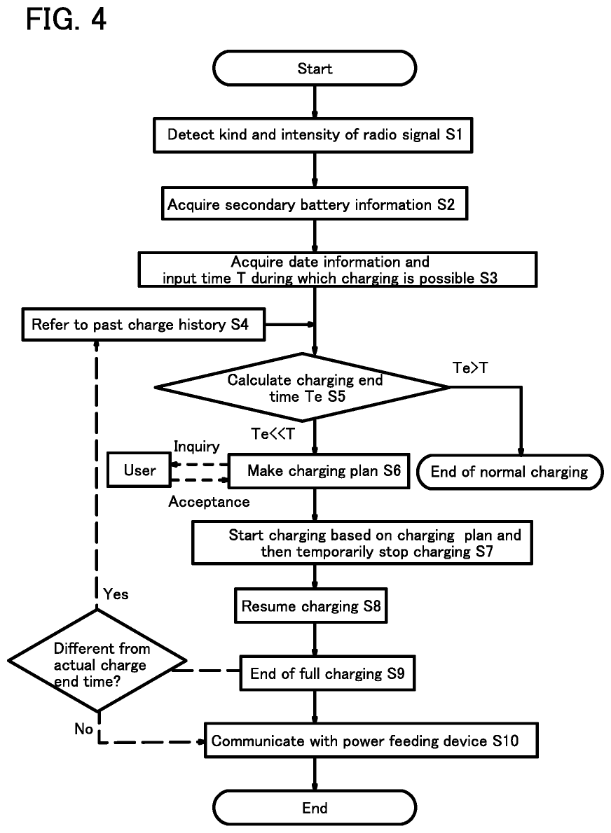

Here, a charging operation of the charging control system in this embodiment is described using drawings. FIG. 4 is a flow chart illustrating an operation.

First, the user places the portable information terminal in a position overlapping with an antenna of the power feeding device connected to the external power supply through the cable for charging.

Then, the microprocessor incorporated in the portable information terminal detects the kind and intensity of a radio signal transmitted from the power feeding device (S 1).

Note that the microprocessor incorporated in the portable information terminal includes an analog-product-sum arithmetic circuit. The details of the analog product-sum arithmetic circuit are described in a later embodiment.

Next, the microprocessor automatically acquires information about the remaining capacity (SOC) of the secondary battery (S2).

Next, date and time information is acquired and time T during which the cable connection is available is input (S3).

Next, if the past charging history is stored in the memory or the like, the microprocessor performs neural network computation with reference to the past charging history (S4) and calculates a charging end time Te (S5). The remaining capacity (SOC), the extent of deterioration, the number of times of charging, or the like is used as a factor of the neural network computation.

If the calculated charging end time Te is later than the time T during which the cable connection is available, normal charging is performed and ended before full charging is reached. Alternatively, fast charging is performed in the case where a user desires to increase the SOC within a limited time. Examples of a method of fast charging are a step control charging method, a −ΔV control charging method, a dT/dT control charging method, and the like.

If the calculated charging end time Te is earlier than the time T during which the cable connection is available, the microprocessor makes a charging plan (S6).

For example, according to the charging plan, charging is performed until the SOC becomes 50% and, after a period of time, recharging is performed so that the SOC becomes 100% immediately before the portable information terminal is made apart from the power feeding device. Although this charging plan may be automatically executed when completed, a process of contacting the user and receiving approval may be interposed. The microprocessor may make and propose a plurality of charging plans to the user so that the user can make a selection from them.

In the case of wireless charging, fast charging can also be performed by adjusting an overlapping of the antenna, the intensity of the signal, or the like. With the use of a plurality of antennas, and charging can also be controlled by adjusting the number of antennas to be used.

Then, charging is started by the microprocessor in accordance with the charging plan, and then temporarily stopped by a charging retention portion (S7). The charging retention portion includes the communication means that stops transmission from the power feeding device.

Next, charging is resumed in accordance with the time when the full charging is to be reached (S8). Then, charging is again stopped by the charging retention portion when the full charging (SOC 100%) is reached; thus the full charging is ended (S9). The charging retention portion performs communication to the power feeding device (S10), and stops transmission of the radio signal. The microprocessor determines whether there is an error to confirm whether the charging end time Te when the full charging (SOC 100%) is actually reached corresponds to the charging end time Te calculated in the previous step (S5), and additionally stores a new charging history as a past charging history. At the time of the next charging, the charging end time Te can be more accurately calculated. Thus, the retention time of the full charging (SOC 100%) can be reduced.

An example in which the period of the stop is provided all at once is described in this embodiment. However, alternatively, the radio signals can be intermittently transmitted and a plurality of brief stops are provided in a charging period, whereby the end time of full charging is intentionally delayed; thus, the retention time of the full charging can also be reduced without a lengthy stop.

Of course, this embodiment is not limited to the order shown in the flow chart. For example, the order of the step 1 (Si) and the step 2 (S2) may be reversed, or the step 1 (S1), the step 2 (S2), and the step 3 (S3) may be simultaneously performed. The step 4 (S4) may be performed before the step 1 (S1).

Although an example in which one secondary battery is included in the portable information terminal is described in this embodiment, there is no particular limitation. This embodiment can also be applied in the case where a plurality of secondary batteries are included in a vehicle.

Although an example in which connection is made to the power source through the cable and an outlet as the external power source is described, there is no particular limitation. This embodiment can be applied also when a storage battery (including a primary battery) employing another method or an auxiliary secondary battery is used instead of the external power source. When including an auxiliary secondary battery, the power feeding device 1300 is portable, capable of charging the portable information terminal at any time, and can also be referred to as a mobile battery. When the power feeding device 1300 and the portable information terminal are carried close to each other, the full charging state can be controlled all the time, and thus the power feeding device 1300 can also be called a charging control device for the portable information terminal.

This embodiment can be freely combined with the other embodiments.

### Embodiment 3

In this embodiment, an example of a configuration of a neural network NN and a specific example of an analog product-sum arithmetic circuit that can be used for the neural network are described.

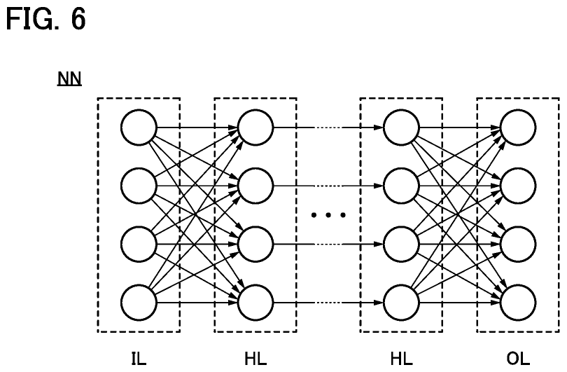

FIG. 6 illustrates an example of a neural network of one embodiment of the present invention. The neural network NN illustrated in FIG. 6 includes an input layer IL, an output layer OL, and a hidden layer (middle layer) HL. The neural network NN can be formed of a neural network including a plurality of hidden layers HL, that is, a deep neural network. Learning in a deep neural network is referred to as deep learning in some cases. The output layer OL, the input layer IL, and the hidden layers HL each include a plurality of neuron circuits, and the neuron circuits provided in the different layers are connected to each other through a synapse circuit.

To the neural network NN, a function of analyzing an operation of a storage battery is added by learning. When a parameter of the storage battery that has been measured is input to the neural network NN, arithmetic processing is performed in each layer. The arithmetic processing in each layer is executed by, for example, the product-sum operation of an output data of the neuron circuits in the previous layer and a weight coefficient. Note that the connection between layers may be a full connection where all of the neuron circuits are connected or a partial connection where some of the neuron circuits are connected.

For example, a convolutional neural network (CNN), which includes a convolution layer and a pooling layer and in which only specific neuron circuits in adjacent layers have connection, may be used.

The data subjected to the convolution is converted using an activation function, and then output to a pooling layer. As the activation function, ReLU (Rectified Linear Units) or the like can be used. ReLU is a function that outputs “0” when an input value is negative and outputs the input value as it is when the input value is greater than or equal to “0”. As the activation function, a sigmoid function, a tan h function, or the like may be used as well.

In the CNN, feature extraction is performed using the above-described convolution processing and pooling processing. Note that the CNN can be composed of a plurality of convolution layers CL and a plurality of pooling layers PL.

A fully-connected layer is preferably placed after several convolution layers and several pooling layers that are arranged alternately, for example.

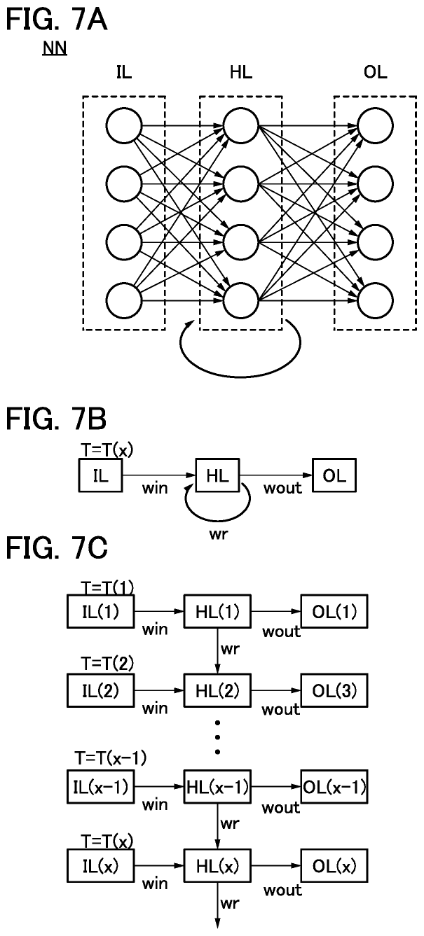

A configuration example of the neural network NN illustrated in FIG. 7(A) is referred to as recurrent neural network (RNN) in some cases. In the neural network illustrated in FIG. 7(A), since a hidden layer HL has a feedback loop, the output from the hidden layer HL is input (fed back) to itself. The use of the RNN allows for analysis of time-series data and data estimation. For example, in the neural network of one embodiment of the present invention, a charging end time can be predicted in some cases.

FIG. 7(B) is a diagram in which an RNN at Time T=T(x) is simplified. A weight coefficient from the input layer IL to the hidden layer HL is represented by Win, a weight coefficient from the hidden layer HL to the output layer OL is represented by Wout, and a weight coefficient that is fed back from the hidden layer HL is represented by Wr.

As illustrated in FIG. 7(C), in the RNN, which is time-developed, layers (an input layer IL(1) to an input layer IL(x), a hidden layer HL(I) to a hidden layer HL(x), and an output layer OL(1) to an output layer OL(x)) can be considered different depending on time (Time T(1) to T(x) in FIG. 7). By time development of an RNN, the RNN can be regarded as a forward propagation network without a feedback loop, like that in FIG. 7(C).

As a neural network, a configuration called a long short-term memory (LSTM) can be used. In LSTM, a hidden layer stores a state by including a memory cell in an RNN, and analysis, such as prediction, about a longer period of time can be performed.

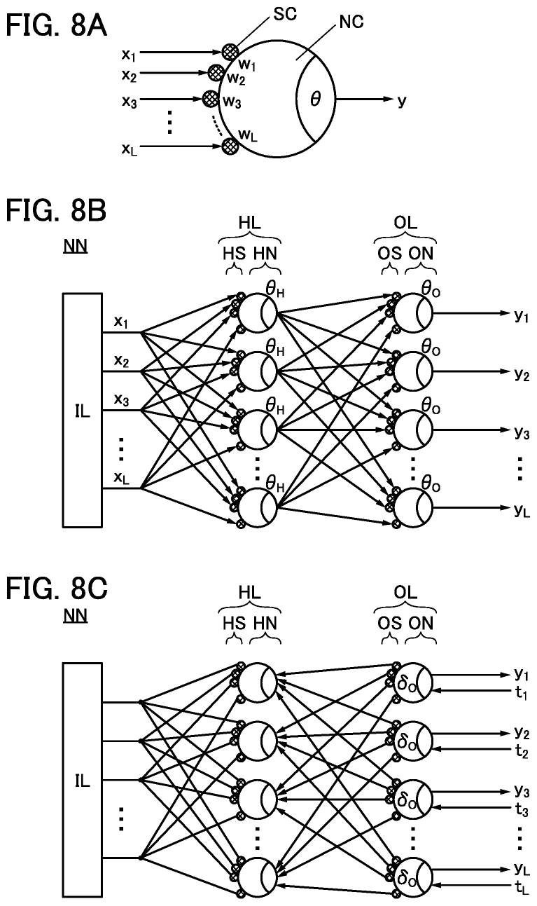

Next, configuration examples of a neural network NN having a learning function will be described. FIG. 8 illustrates configuration examples of the neural network NN. The neural network NN is composed of neuron circuits NC and synapse circuits SC provided between the neuron circuits.

FIG. 8(A) illustrates a configuration example of a neuron circuit NC and synapse circuits SC which constitute the neural network NN. Input data x₁ to x_{L} (L is a natural number) are input to the synapse circuits SC. In addition, the synapse circuits SC each have a function of storing a weight coefficient wₖ (k is an integer greater than or equal to 1 and less than or equal to L). The weight coefficient wₖ corresponds to the connection strength between the neuron circuits NC.

When the input data x₁ to x_{L} are input to the synapse circuits SC, the sum of the products (xₖwₖ) for k=1 to L (i.e., x₁w₁+x₂w₂+ . . . +x_{L}w_{L}) of input data xₖ input to the synapse circuit SC and the weight coefficient wₖ stored in the synapse circuit SC, that is, a value obtained by the product-sum operation of xₖ and wₖ is supplied to the neuron circuit NC. When the value is larger than the threshold θ of the neuron circuit NC, the neuron circuit NC outputs a high-level signal y. This phenomenon is referred to as firing of the neuron circuit NC.

FIG. 8(B) shows a model of a hierarchical perceptron neural network NN using the neuron circuits NC and the synapse circuits SC. The neural network NN includes an input layer IL, a hidden layer (middle layer) HL, and an output layer OL.

The input data x₁ to X_{L} are output from the input layer IL. The hidden layer HL includes hidden synapse circuits HS and hidden neuron circuits HN. The output layer OL includes output synapse circuits OS and output neuron circuits ON.

A value obtained by the product-sum operation using the input data xₖ and the weight coefficient wₖ that is held in the hidden synapse circuit HS is supplied to the hidden neuron circuit HN. Then, a value obtained by the product-sum operation using the output of the hidden neuron circuit HN and the weight coefficient wₖ that is held in the output synapse circuit OS is supplied to the output neuron circuit ON. Then, output data y₁ to y_{L} are output from the output neuron circuits ON.

As described above, the neural network NN to which predetermined input data is supplied has a function of outputting, as output data, values corresponding to weight coefficients retained in the synapse circuits SC and the thresholds θ(θ_{H} and θ_{O})) of the neuron circuits.

The neural network NN can perform supervised learning by the input of teacher data. FIG. 8(C) a model of the neural network NN which performs supervised learning using backpropagation.

The backpropagation method is a method of changing a weight coefficient wₖ of a synapse circuit so that the error between output data from a neural network and a teacher signal is reduced. Specifically, the weight coefficient wₖ of the hidden synapse circuit HS is changed in accordance with an error δ_{O} that is determined on the basis of the output data y₁ to y_{L} and the teacher data t₁ to t_{L}. A weight coefficient wₖ of a synapse circuit SC in the previous stage is changed in accordance with the amount of change in the weight coefficient wₖ of the hidden synapse circuit HS. In this manner, weight coefficients of the synapse circuits SC are sequentially changed on the basis of the teacher data t₁ to t_{L}, so that the neural network NN can perform learning.

Note that one hidden layers HL is illustrated in FIG. 8(B) and FIG. 8(C) but the number of the hidden layers HL can be two or more. The use of a neural network including two or more hidden layers HL (a deep neural network (DNN)) enables deep learning. Accordingly, the accuracy of the calculation of the charging end time can be increased.

As described with reference to FIG. 7(C), by time development of an RNN, the RNN can be regarded as a forward propagation network without a feedback loop. In the forward propagation network, a weight coefficient can be changed on the basis of teacher data by the above backpropagation method or the like.

The neural network illustrated in FIGS. 6 to 8 is executed by a huge number of product-sum operations. In the case where the arithmetic processing is performed by a digital circuit, a huge number of transistors are needed, resulting in inefficiency and high power consumption. Thus, the above product-sum operations are preferably performed by an analog product-sum operation circuit (hereinafter referred to as APS (Analog Product-Sum circuit)). The APS preferably includes an analog memory. The APS stores a weight coefficient obtained by learning, in the analog memory, whereby the APS can perform the product-sum operations using analog data as it is. Consequently, the APS enables a neural network to be formed efficiently with a small number of transistors.

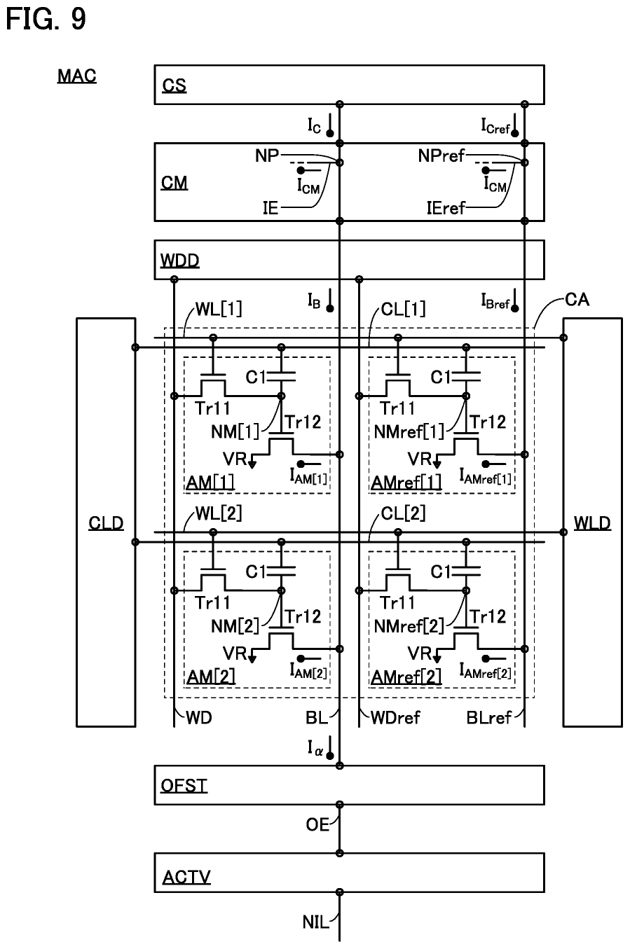

FIG. 9 illustrates a configuration example of the product-sum operation circuit. A product-sum operation circuit MAC illustrated in FIG. 9 is a circuit that performs product-sum operation using first data retained in a memory cell described below and input second data. Note that the first data and the second data can be analog data or multilevel data (discrete data).

The product-sum operation circuit MAC includes a current supply circuit CS, a current mirror circuit CM, a circuit WDD, a circuit WLD, a circuit CLD, an offset circuit OFST an activation function circuit ACTV, and the memory cell array CA.

The memory cell array CA includes a memory cell AM[1], a memory cell AM[2], a memory cell AMref[1], and a memory cell AMref[2]. The memory cell AM[1] and the memory cell AM[2] each have a function of retaining the first data, and the memory cell AMref[1] and the memory cell AMref[2] each have a function of retaining reference data that is needed to perform product-sum operation. The reference data can be analog data or multilevel data (discrete data), like the first data and the second data.

In the memory cell array CA in FIG. 9, memory cells are arranged in a matrix of two rows and two columns; however, the memory cell array CA may have a configuration in which memory cells are arranged in a matrix of three or more rows and three or more columns. In the case where multiplication is performed instead of product-sum operation, the memory cell array CA may have a configuration in which memory cells are arranged in a matrix of one row and two or more columns.

The memory cell AM[1], the memory cell AM[2], the memory cell AMref[1], and the memory cell AMref[2] each include a transistor Tr11, a transistor Tr12, and a capacitor C1.

Note that the transistor Tr11 is preferably an OS transistor.

The use of an OS transistor as the transistor Tr12 allows the transistor Tr12 to be formed concurrently with the transistor Tr11, leading to a reduction in the number of manufacturing steps for the product-sum operation circuit, in some cases. A channel formation region of the transistor Tr12 may be amorphous silicon, polycrystalline silicon, or the like instead of an oxide.

In each of the memory cell AM[1], the memory cell AM[2], the memory cell AMref[1], and the memory cell AMref[2], a first terminal of the transistor Tr11 is electrically connected to a gate of the transistor Tr12. A first terminal of the transistor Tr12 is electrically connected to a wiring VR. A first terminal of the capacitor C1 is electrically connected to the gate of the transistor Tr12.

In the memory cell AM[1], a second terminal of the transistor Tr11 is electrically connected to a wiring WD, and a gate of the transistor Tr11 is electrically connected to a wiring WL[1]. A second terminal of the transistor Tr12 is electrically connected to a wiring BL, and a second terminal of the capacitor C1 is electrically connected to a wiring CL[1]. In FIG. 9, in the memory cell AM[1], a connection portion of the first terminal of the transistor Tr11, the gate of the transistor Tr12, and the first terminal of the capacitor CI is a node NM[1]. In addition, a current that flows from the wiring BL to the second terminal of the transistor Tr12 is I_{AM[1]}.

In the memory cell AM[2], a second terminal of the transistor Tr11 is electrically connected to the wiring WD, and a gate of the transistor Tr11 is electrically connected to a wiring WL[2]. A second terminal of the transistor Tr12 is electrically connected to the wiring BL, and a second terminal of the capacitor C1 is electrically connected to a wiring CL[2]. In FIG. 9, in the memory cell AM[2], a connection portion of the first terminal of the transistor Tr11, the gate of the transistor Tr12, and the first terminal of the capacitor C1 is a node NM[2]. In addition, a current that flows from the wiring BL to the second terminal of the transistor Tr12 is I_{AM[2]}.

In the memory cell AMref[1], a second terminal of the transistor Tr11 is electrically connected to a wiring WDref, and a gate of the transistor Tr11 is electrically connected to the wiring WL[1]. A second terminal of the transistor Tr12 is electrically connected to a wiring BLref, and a second terminal of the capacitor C1 is electrically connected to the wiring CL[1]. In FIG. 9, in the memory cell AMref[1], a connection portion of the first terminal of the transistor Tr11, the gate of the transistor Tr12, and the first terminal of the capacitor C1 is a node NMref[1]. In addition, a current that flows from the wiring BLref to the second terminal of the transistor Tr12 is I_{AMref[1]}.

In the memory cell AMref[2], a second terminal of the transistor Tr11 is electrically connected to the wiring WDref, and a gate of the transistor Tr11 is electrically connected to the wiring WL[2]. A second terminal of the transistor Tr12 is electrically connected to the wiring BLref, and a second terminal of the capacitor C1 is electrically connected to the wiring CL[2]. In FIG. 9, in the memory cell AMref[2], a connection portion of the first terminal of the transistor Tr11, the gate of the transistor Tr12, and the first terminal of the capacitor C1 is a node NMref[2]. In addition, a current that flows from the wiring BLref to the second terminal of the transistor Tr12 is I_{AMref[2]}.

The node NM[1], the node NM[2], the node NMref[1], and the node NMref[2] described above function as retention nodes of their respective memory cells.

The wiring VR is a wiring for supplying current between the first terminal and the second terminal of the transistor Tr12 in each of the memory cell AM[1], the memory cell AM[2], the memory cell AMref[1], and the memory cell AMref[2]. Thus, the wiring VR functions as a wiring for supplying a predetermined potential. In this embodiment, a potential to be supplied from the wiring VR is a reference potential or a potential lower than the reference potential.

The current supply circuit CS is electrically connected to the wiring BL and the wiring BLref. The current supply circuit CS has a function of supplying current to the wiring BL and the wiring BLref. Note that the amounts of current supplied to the wiring BL and the wiring BLref may be different from each other. In this configuration example, a current that is supplied from the current supply circuit CS to the wiring BL is I_{C}, and a current that is supplied from the current supply circuit CS to the wiring BLref is I_{Cref}.

The current mirror circuit CM includes a wiring IE and a wiring IEref. The wiring IE is electrically connected to the wiring BL, and in FIG. 9, a connection portion of the wiring IE and the wiring BL is shown as a node NP. The wiring IEref is electrically connected to the wiring BLref, and in FIG. 9, a connection portion of the wiring IEref and the wiring BLref is shown as a node NPref. The current mirror circuit CM has a function of letting out current according to the potential of the node NPref from the node NPref of the wiring BLref to the wiring IEref, and letting out the same amount of current as the above current from the node NP of the wiring BL to the wiring IE. In FIG. 9, a current that is let out from the node NP to the wiring IE and a current that is let out from the node NPref to the wiring IEref are represented by I_{CM}. In addition, a current that flows from the current mirror circuit CM to the memory cell array CA in the wiring BL is represented by I_{B}, and a current that flows from the current mirror circuit CM to the memory cell array CA in the wiring BLref is represented by I_{Bref}.

The circuit WDD is electrically connected to the wiring WD and the wiring WDref. The circuit WDD has a function of transmitting data that is to be stored in each memory cell included in the memory cell array CA.

The circuit WLD is electrically connected to the wiring WL[1] and the wiring WL[2]. The circuit WLD has a function of selecting a memory cell to which data is written in data writing to the memory cell included in the memory cell array CA.

The circuit CLD is electrically connected to the wiring CL[1] and the wiring CL[2]. The circuit CLD has a function of applying a potential to the second terminal of the capacitor C1 of each memory cell included in the memory cell array CA.

The circuit OFST is electrically connected to the wiring BL and a wiring OE. The circuit OFST has a function of measuring the amount of current flowing from the wiring BL to the circuit OFST and/or the amount of change in current flowing from the wiring BL to the circuit OFST. In addition, the circuit OFST has a function of outputting the measurement result to the wiring OE. Note that the circuit OFST may have a configuration in which the measurement result is output as it is as current to the wiring OE or have a configuration in which the measurement result is converted into voltage and then output to the wiring OE. In FIG. 9, a current flowing from the wiring BL to the circuit OFST is represented I_{α}.

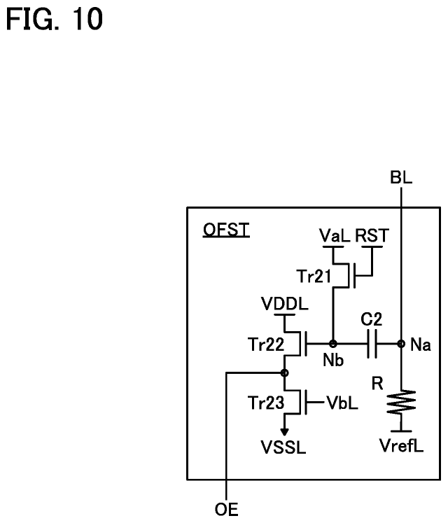

The circuit OFST can have a configuration in FIG. 10, for example. In FIG. 10, the circuit OFST includes a transistor Tr21, a transistor Tr22, a transistor Tr23, a capacitor C2, and a resistor R.

A first terminal of the capacitor C2 is electrically connected to the wiring BL, and a first terminal of the resistor R is electrically connected to the wiring BL. A second terminal of the capacitor C2 is electrically connected to a first terminal of the transistor Tr21, and the first terminal of the transistor Tr21 is electrically connected to a gate of the transistor Tr22. A first terminal of the transistor Tr22 is electrically connected to a first terminal of the transistor Tr23, and the first terminal of the transistor Tr23 is electrically connected to the wiring OE. An electrical connection point of the first terminal of the capacitor C2 and the first terminal of the resistor R is a node Na, and an electrical connection point of the second terminal of the capacitor C2, the first terminal of the transistor Tr21, and the gate of the transistor Tr22 is a node Nb.

A second terminal of the resistor R is electrically connected to a wiring VrefL. A second terminal of the transistor Tr21 is electrically connected to a wiring VaL, and a gate of the transistor Tr21 is electrically connected to a wiring RST. A second terminal of the transistor Tr22 is electrically connected to a wiring VDDL. A second terminal of the transistor Tr23 is electrically connected to a wiring VSSL, and a gate of the transistor Tr23 is electrically connected to a wiring VbL.

The wiring VrefL is a wiring for supplying a potential Vref, the wiring VaL is a wiring for supplying a potential Va, and the wiring VbL is a wiring for supplying a potential Vb. The wiring VDDL is a wiring for supplying a potential VDD, and the wiring VSSL is a wiring for supplying a potential VSS. Particularly in this configuration example of the circuit OFST the potential VDD is a high-level potential and the potential VSS is a low-level potential. The wiring RST is a wiring for supplying a potential for switching the conduction state and the non-conduction state of the transistor Tr21.

In the circuit OFST illustrated in FIG. 10, a source follower circuit is composed of the transistor Tr22, the transistor Tr23, the wiring VDDL, the wiring VSSL, and the wiring VbL.

In the circuit OFST illustrated in FIG. 10, owing to the resistor R and the wiring VrefL, a potential according to current flowing through the wiring BL and the resistance of the resistor R is supplied to the node Na.

An operation example of the circuit OFST illustrated in FIG. 10 is described. When first-time current (hereinafter referred to as first current) flows through the wiring BL, a potential according to the first current and the resistance of the resistor R is supplied to the node Na owing to the resistor R and the wiring VrefL. At this time, the transistor Tr21 is brought into a conduction state so that the potential Va is supplied to the node Nb. After that, the transistor Tr21 is brought into a non-conduction state.

Next, when second-time current (hereinafter referred to as second current) flows through the wiring BL, a potential according to the second current and the resistance of the resistor R is supplied to the node Na owing to the resistor R and the wiring VrefL as in the case where the first current flows. At this time, the node Nb is in a floating state; thus, a change in the potential of the node Na changes the potential of the node Nb because of capacitive coupling. When the change in the potential of the node Na is ΔV_{Na} and the capacitive coupling coefficient is 1, the potential of the node Nb is Va+ΔV_{Na}. When the threshold voltage of the transistor Tr22 is Vₜₕ, a potential Va+ΔV_{Na}−Vₜₕ is output through the wiring OE. When the potential Va is the threshold voltage Vₜₕ here, a potential ΔL_{Na} can be output through the wiring OE.

The potential ΔV_{Na} is determined by the amount of change from the first current to the second current, the resistor R, and the potential Vref. The resistor R and the potential Vref can be regarded as known; therefore, the use of the circuit OFST illustrated in FIG. 10 allows the amount of change in current flowing through the wiring BL to be obtained from the potential ΔV_{Na}.

The activation function circuit ACTV is electrically connected to the wiring OE and a wiring NIL. The variation in the amount of current measured by the circuit OFST is input to the activation function circuit ACTV through the wiring OE. The activation function circuit ACTV is a circuit that performs arithmetic operation according to a function system defined in advance, on the variation in the amount of current. As the function system, for example, a sigmoid function, a tan h function, a softmax function, a ReLU function, a threshold function, or the like can be used, and these functions are used as activation functions in a neural network.

### <Operation Example of Product-Sum Operation Circuit>

Next, an operation example of the product-sum operation circuit MAC will be described.

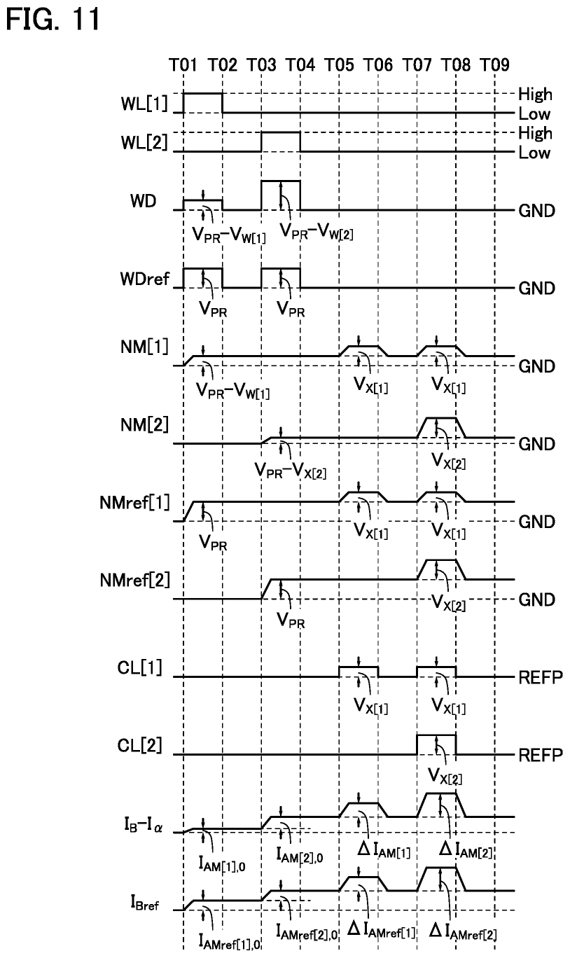

FIG. 11 shows a timing chart of the operation example of the product-sum operation circuit MAC. The timing chart of FIG. 11 shows changes in the potentials of the wiring WL[1], the wiring WL[2], the wiring WD, the wiring WDref, the node NM[1], the node NM[2], the node NMref[1], the node NMref[2], the wiring CL[1], and the wiring CL[2] and changes in the amounts of current I_{B}−I_{α} and current I_{Bref} from Time T01 to Time T09. In particular, the current I_{B}−I_{α} represents the total amount of current that flows from the wiring BL to the memory cell AM[1] and the memory cell AM[2] in the memory cell array CA.

### <<From Time T01 to Time T02>>

During a period from Time T01 to Time T02, a high-level potential (denoted by High in FIG. 11) is applied to the wiring WL[1], and a low-level potential (denoted by Low in FIG. 11) is applied to the wiring WL[2]. Furthermore, a potential higher than a ground potential (denoted by GND in FIG. 11) by V_{PR}−V_{W[1]} is applied to the wiring WD, and a potential higher than the ground potential by V_{PR} is applied to the wiring WDref. Moreover, a reference potential (denoted by REFP in FIG. 11) is applied to each of the wiring CL[1] and the wiring CL[2].

The potential V_{W[1]} is a potential corresponding to one piece of the first data. The potential V_{PR} is a potential corresponding to the reference data.

At this time, the high-level potential is applied to each of the gates of the transistors Tr11 in the memory cell AM[1] and the memory cell AMref[1], and the transistors Tr11 in the memory cell AM[1] and the memory cell AMref[1] are each brought into a conduction state. Thus, the potential of the node NM[1] becomes V_{PR}−V_{W[1]}, and the potential of the node NMref[1] becomes V_{PR}.

When the current flowing from the wiring BL to the first terminal of the transistor Tr12 in the memory cell AM[1] through its second terminal is I_{AM[1],0}, I_{AM[1],0} can be expressed by the following formula.

[Formula 1]

I_{AM[1],0}=k(V_{PR}−V_{W[1]}−Vₜₕ)² (E1)

Note that k is a constant determined by the channel length, the channel width, the mobility, the capacitance of a gate insulating film, and the like of the transistor Tr12. Furthermore, Vₜₕ is the threshold voltage of the transistor Tr12.

When current flowing from the wiring BLref to the first terminal of the transistor Tr12 in the memory cell AMref[1] through its second terminal is I_{AMref[1],0}, I_{AMref[1],0} can be expressed similarly by the following formula.

[Formula 2]

I_{AMref[1],0}=k(V_{PR}−Vₜₕ)² (E2)

Note that since the low-level potential is applied to each of the gates of the transistors Tr11 in the memory cell AM[2] and the memory cell AMref[2], the transistors Tr11 in the memory cell AM[2] and the memory cell AMref[2] are each brought into a non-conduction state. Thus, the potentials are not written to the node NM[2] and the node NMref[2].

### <<From Time T02 to Time T03>>

During a period from Time T02 to Time T03, the low-level potential is applied to the wiring WL[1]. At this time, the low-level potential is applied to each of the gates of the transistors Tr11 in the memory cell AM[1] and the memory cell AMref[1]; accordingly, the transistors Tr11 in the memory cell AM[1] and the memory cell AMref[1] are each brought into a non-conduction state.

In addition, the low-level potential remains applied to the wiring WL[2] from before Time T02. Thus, the transistors Tr11 in the memory cell AM[2] and the memory cell AMref[2] each remain in a non-conduction state since before Time T02. Thus, the potentials of the node NM[1], the node NM[2], the node NMref[1], and the node NMref[2] are each retained during the period from Time T02 to Time T03. When OS transistors are used as the transistors Tr11, the leakage current flowing between the first terminals and the second terminals of the transistors Tr11 can be made low, which makes it possible to retain the potential at each node for a long time. Since the ground potential is applied to the wiring WD and the wiring WDref and the transistors Tr11 are in off states, the potentials retained at the nodes are not rewritten by applying potentials from the wiring WD and the wiring WDref.

### <<From Time T03 to Time T04>>

During a period from Time T03 to Time T04, the low-level potential is applied to the wiring WL[1], and the high-level potential is applied to the wiring WL[2]. Furthermore, a potential higher than the ground potential by V_{PR}−V_{w[2]} is applied to the wiring WD, and a potential higher than the ground potential by V_{PR} is applied to the wiring WDref. Moreover, the reference potential is continuously applied to each of the wiring CL[1] and the wiring CL[2] since before Time T02.

Note that the potential V_{w[2]} is a potential corresponding to one piece of the first data.

At this time, the high-level potential is applied to each of the gates of the transistors Tr11 in the memory cell AM[2] and the memory cell AMref[2]; accordingly, the transistors Tr11 in the memory cell AM[2] and the memory cell AMref[2] are each brought into a conduction state. Thus, the potential of the node NM[2] becomes V_{PR}−V_{W[2]}, and the potential of the node NMref[2] becomes V_{PR}.

When the current flowing from the wiring BL to the first terminal of the transistor Tr12 in the memory cell AM[2] through its second terminal is I_{AM[2],0}, I_{AM[2],0} can be expressed by the following formula.

[Formula 3]

I_{AM[2],0}=k(V_{PR}−V_{W[2]}−Vₜₕ)² (E3)

When current flowing from the wiring BLref to the first terminal of the transistor Tr12 in the memory cell AMref[2] through its second terminal is I_{AMref[2],0}, I_{AMref[2],0} can be expressed similarly by the following formula.

[Formula 4]

I_{AMref[2],0}=k(V_{PR}−Vₜₕ)² (E4)

### <<From Time T04 to Time T05>>

Here, currents that flow in the wiring BL and the wiring BLref during a period from Time T04 to Time T05 are described.

Current from the current supply circuit CS is supplied to the wiring BLref. In addition, current is let out by the current mirror circuit CM, the memory cell AMref[1], and the memory cell AMref[2] to the wiring BLref. When the current supplied from the current supply circuit CS is I_{Cref} and the current let out by the current mirror circuit CM is I_{CM,0} in the wiring BLref, the following formula is satisfied according to Kirchhoff's law.

[Formula 5]

I_{Cref}−I_{CM,0}=I_{AMref[1],0}+I_{AMref[2],0} (E5)

When the current supplied from the current supply circuit CS is I_{C,0} and the current that flows from the wiring BL to the circuit OFST is I_{α,0} in the wiring BL, the following formula is satisfied according to Kirchhoff's law.

[Formula 6]

I_{C}−I_{CM,0}=I_{AM[1],0}+I_{AM[2],0}+I_{α,0} (E6)

### <<From Time T05 to Time T06>>

During a period from Time T05 to Time T06, a potential higher than the reference potential by V_{X[1]} is applied to the wiring CL[1]. At this time, the potential V_{X[1]} is applied to the second terminal of the capacitor C1 in each of the memory cell AM[1] and the memory cell AMref[1], so that the potentials of the gates of the transistors Tr12 increase.

The potential V_{X[1]} is a potential corresponding to one piece of the second data.

Note that an increase in the potential of the gate of the transistor Tr12 corresponds to a potential obtained by multiplying a change in the potential of the wiring CL[1] by a capacitive coupling coefficient determined by the memory cell configuration. The capacitive coupling coefficient is calculated using the capacitance of the capacitor C1, the gate capacitance of the transistor Tr12, and the parasitic capacitance. In this operation example, to avoid complexity of description, description is made on the assumption that an increase in the potential of the wiring CL[1] is equal to the increase in the potential of the gate of the transistor Tr12. This corresponds to the case where the capacitive coupling coefficient in each of the memory cell AM[1] and the memory cell AMref[1] is set to 1.

Since the capacitive coupling coefficient is set to 1, when the potential V_{X[1]} is applied to the second terminal of the capacitor C1 in each of the memory cell AM[1] and the memory cell AMref[1], the potentials of the node NM[1] and the node NMref[1] each increase by V_{X[1]}.

Here, the current flowing from the second terminal to the first terminal of the transistor Tr12 in each of the memory cell AM[1] and the memory cell AMref[1] is considered. When the current flowing from the wiring BL to the first terminal of the transistor Tr12 in the memory cell AM[1] through its second terminal is I_{AM[1],1}, I_{AM[1],1} can be expressed by the following formula.

[Formula 7]

I_{AM[1],1}=k(V_{PR}−V_{W[1]}+V_{X[1]}−Vₜₕ)² (E7)

In other words, by application of the potential V_{X[1]} to the wiring CL[1], the current flowing from the wiring BL to the first terminal of the transistor Tr12 in the memory cell AM[1] through its second terminal increases by I_{AM[1],1}−I_{AM[1],0} (denoted by ΔI_{AM[1]} in FIG. 11).

Similarly, when current flowing from the wiring BLref to the first terminal of the transistor Tr12 in the memory cell AMref[1] through its second terminal is I_{AMref[1],1}, I_{AMref[1],1} can be expressed by the following formula.

[Formula 8]

I_{AMref[1],1}=k(V_{PR}+V_{X[1]}−Vₜₕ)² (E8)

In other words, by application of the potential V_{X[1]} to the wiring CL[1], the current flowing from the wiring BLref to the first terminal of the transistor Tr12 in the memory cell AMref[1] through its second terminal increases by I_{AMref[1],1}−I_{AMref[1],0} (denoted by ΔI_{AMref[1]} in FIG. 11).

When the current let out by the current mirror circuit CM is I_{CM,1} in the wiring BLref, the following formula is satisfied according to Kirchhoff's law.

[Formula 9]

I_{Cref}−I_{CM,1}=I_{AMref[1],1}+I_{AMref[2],0} (E9)

When the current that flows from the wiring BL to the circuit OFST is I_{α,1} in the wiring BL, the following formula is satisfied according to Kirchhoffs law.

[Formula 10]

I_{C}−I_{CM,1}=I_{AM[1],1}+I_{AM[2],0}+I_{α,1} (E10)

Note that ΔI_{α} represents the difference between the current I_{α,0} flowing from the wiring BL to the wiring OFST during the period from Time T04 to Time T05 and the current I_{α,1} flowing from the wiring BL to the wiring OFST during the period from Time T05 to Time T06. Hereinafter. ΔI_{α} is referred to as a difference current in the product-sum operation circuit MAC. The difference current ΔI_{α} can be expressed by the following formula, using Formula (E1) to Formula (E10).

[Formula 11]

ΔI_{α}=I_{α,1}−I_{α,0}=2kV_{W[1]}V_{X[1]} (E11)

### <<From Time T06 to Time T07>>

During a period from Time T06 to Time T07, the ground potential is applied to the wiring CL[1]. At this time, the ground potential is applied to the second terminal of the capacitor C1 in each of the memory cell AM[1] and the memory cell AMref[l]; thus, the potentials of the node NM[1] and the node NMref[1] return to the potentials during the period from Time T04 to Time T05.

### <<From Time T07 to Time T08>>

During a period from Time T07 to Time T08, a potential higher than the reference potential by V_{X[1]} is applied to the wiring CL[1], and a potential higher than the reference potential by V_{X[2]} is applied to the wiring CL[2]. At this time, the potential V_{X[1]} is applied to the second terminal of the capacitor C1 in each of the memory cell AM[1] and the memory cell AMref[1], and the potential V_{X[2]} is applied to the second terminal of the capacitor C1 in each of the memory cell AM[2] and the memory cell AMref[2]. Consequently, the potential of the gate of the transistor Tr12 in each of the memory cell AM[1], the memory cell AM[2], the memory cell AMref[1], and the memory cell AMref[2] increases.

When the current flowing from the wiring BL to the first terminal of the transistor Tr12 in the memory cell AM[2] through its second terminal is I_{AM[2],1}, I_{AM[2],1} can be expressed by the following formula.

[Formula 12]

I_{AM[2],1}=k(V_{PR}−V_{W[2]}+V_{X[2]}−Vₜₕ)² (E12)

Similarly, when current flowing from the wiring BLref to the first terminal of the transistor Tr12 in the memory cell AMref[2] through its second terminal is I_{AMref[2],1}, I_{AMref[2],1} can be expressed by the following formula.

[Formula 13]

I_{AMref[2],1}=k(V_{PR}+V_{X[2]}+Vₜₕ)² (E13)

When the current let out by the current mirror circuit CM is I_{CM,2} in the wiring BLref, the following formula is satisfied according to Kirchhoffs law.

[Formula 14]

I_{Cref}−I_{CM,2}=I_{AMref[1],1}+I_{AMref[2],1} (E14)

When the current that flows from the wiring BL to the circuit OFST is I_{α,3} in the wiring BL, the following formula is satisfied according to Kirchhoff's law.

[Formula 15]

I_{C}−I_{CM0,2}=I_{AM[1],1}+I_{AM[2],1}+I_{α,3} (E15)

The difference current ΔI_{α}, the difference between the current I_{α,0} flowing from the wiring BL to the wiring OFST during the period from Time T04 to Time T05 and the current I_{α,3} flowing from the wiring BL to the wiring OFST during the period from Time T07 to Time T08, can be expressed by the following formula, using Formula (E1) to Formula (E8) and Formula (E12) to Formula (E15).

[Formula 16]

ΔI_{α}=I_{α,0}−I_{α,3}=2k(V_{W[1]}V_{X[1]}+V_{W[2]}V_{X[2]}) (E16)

As shown by Formula (E16), the difference current ΔI_{α} input to the circuit OFST has a value corresponding to the sum of products of the potential V_{W}, which is a plurality of pieces of the first data, and the potential V_{X}, which is a plurality of pieces of the second data. In other words, when the difference current ΔI_{α} is measured by the circuit OFST the value of the sum of products of the first data and the second data can be obtained.

### <<From Time T08 to Time T09>>

During a period from Time T08 to Time T09, the reference potential is applied to the wiring CL[1] and the wiring CL[2]. At this time, the reference potential is applied to the second terminal of the capacitor CI in each of the memory cell AM[1], the memory cell AM[2], the memory cell AMref[1], and the memory cell AMref[2]; thus, the potentials of the node NM[1], the node NM[2], the node NMref 11, and the node NMref[2] return to the potentials during the period from Time T06 to Time T07.

Although V_{X[1]} was applied to the wiring CL[1] during the period from Time T05 to Time T06 and V_{X[1]} and V_{X[2]} were applied to the wiring CL[1] and the wiring CL[2], respectively, during the period from Time T07 to Time T08, potentials that are applied to the wiring CL[1] and the wiring CL[2] may be lower than the reference potential REFP. In the case where a potential lower than the reference potential REFP is applied to the wiring CL[1] and/or the wiring CL[2], the potential of a retention node of a memory cell connected to the wiring CL[1] and/or the wiring CL[2] can be decreased by capacitive coupling. Thus, multiplication of the first data and one piece of the second data, which is a negative value, can be performed in the product-sum operation. For example, in the case where −V_{X[2]}, instead of V_{X[2]}, is applied to the wiring CL[2] during the period from Time T07 to lime T08, the difference current ΔI_{α} can be expressed by the following formula.

[Formula 17]

ΔI_{α}=I_{α,1}−I_{α,3}=2k(V_{W[1]}V_{X[1]}−V_{W[2]}V_{X[2]}) (E17)

Although the memory cell array CA including memory cells arranged in a matrix of two rows and two columns is used in this operation example, product-sum operation can be similarly performed in a memory cell array of one row and two or more columns and a memory cell array of three or more rows and three or more columns. In a product-sum operation circuit of such a case, memory cells in one of the plurality of columns are used for retaining reference data (potential V_{PR}), whereby product-sum arithmetic processing of the rest of the columns among the plurality of columns can be executed concurrently. That is, when the number of columns in a memory cell array is increased, an arithmetic circuit that achieve high-speed product-sum arithmetic processing can be provided. Furthermore, increasing the number of rows allows an increase in the number of terms to be added to each other in the product-sum operation. The difference current ΔI_{α} when the number of rows is increased can be expressed by the following formula.

$$\begin{matrix}[ Formula 18 ] & \\ Δ {I}_{a} = 2 k {\sum }_{i} {V}_{W [ i ]} {V}_{X [ i ]} & ( E 18 )\end{matrix}$$

By the way, in the product-sum operation circuit described in this embodiment, the number of the rows of the memory cells AM corresponds to the number of neurons in the previous layer. In other words, the number of the rows of the memory cells AM corresponds to the number of output signals of the neurons in the previous layer that are input to the next layer. The number of the columns of the memory cells AM corresponds to the number of neurons in the next layer. In other words, the number of the columns of the memory cells AM corresponds to the number of output signals of the neurons that are output from the next layer. That is to say, the number of the rows and the number of the columns of the memory cell array of the product-sum operation circuit are determined depending on the number of neurons in each of the previous layer and the next layer; thus, the number of the rows and the number of the columns of the memory cell array are determined depending on the desired configuration of the neural network.

This embodiment can be combined with any of the other embodiments as appropriate.

### Embodiment 4

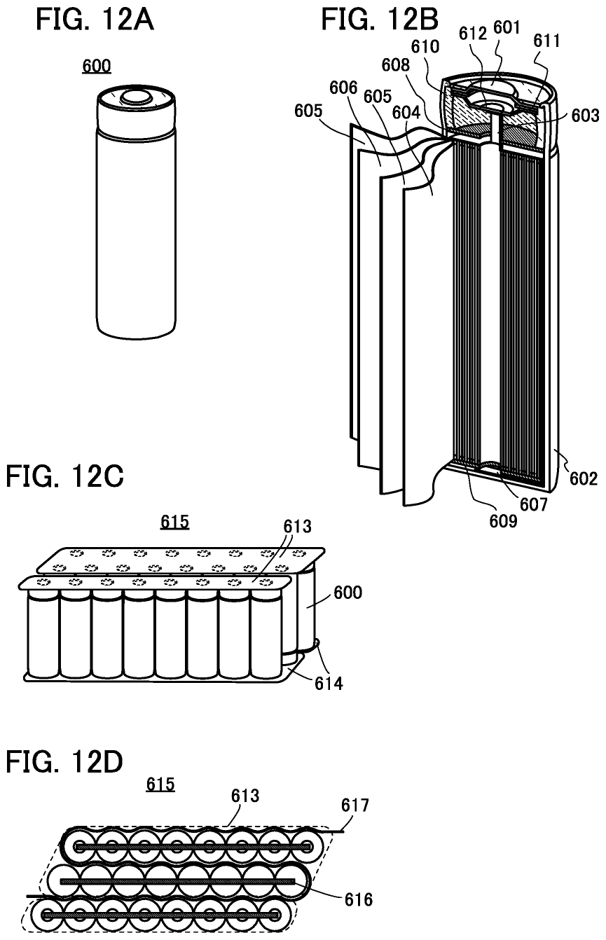

In this embodiment, an example of a cylindrical secondary battery will be described with reference to FIG. 12. A cylindrical secondary battery 600 includes, as illustrated in FIG. 12(A), a positive electrode cap (battery lid) 601 on the top surface and a battery can (outer can) 602 on the side and bottom surfaces. The positive electrode cap 601 and the battery can (outer can) 602 are insulated from each other by a gasket (insulating packing) 610.

FIG. 12(B) is a schematic cross-sectional view of the cylindrical secondary battery. Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a metal having a corrosion-resistant property to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. The secondary battery is formed of a positive electrode containing an active material such as lithium cobalt oxide (LiCoO₂) or lithium iron phosphate (LiFePO₄), a negative electrode composed of a carbon material such as graphite capable of occluding and releasing lithium ions, a nonaqueous electrolytic solution in which an electrolyte composed of a lithium salt such as LiBF₄ or LiPF₆ is dissolved in an organic solvent such as ethylene carbonate or diethyl carbonate, and the like.

Since the positive electrode and the negative electrode of the cylindrical storage battery are wound, active materials are preferably formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

As illustrated in FIG. 12(C), a plurality of secondary batteries 600 may be sandwiched between a conductive plate 613 and a conductive plate 614 to form a module 615. The plurality of secondary batteries 600 may be connected parallel to each other, connected in series, or connected in series after being connected parallel to each other. With the module 615 including the plurality of secondary batteries 600, large electric power can be extracted.

FIG. 12(D) is a top view of the module 615. The conductive plate 613 is shown by a dotted line for clarity of the drawing. As illustrated in FIG. 12(D), the module 615 may include a wiring 616 which electrically connects the plurality of secondary batteries 600 to each other. It is possible to provide the conductive plate 613 over the wiring 616 to overlap with each other. In addition, a temperature control device 617 may be provided between the plurality of secondary batteries 600. When the secondary batteries 600 are heated excessively, the temperature control device 617 can cool them, and when the secondary batteries 600 are cooled too much, the temperature control device 617 can heat them. Thus, the performance of the module 615 is not easily influenced by the outside air temperature.

### [Structural Examples of Secondary Battery]

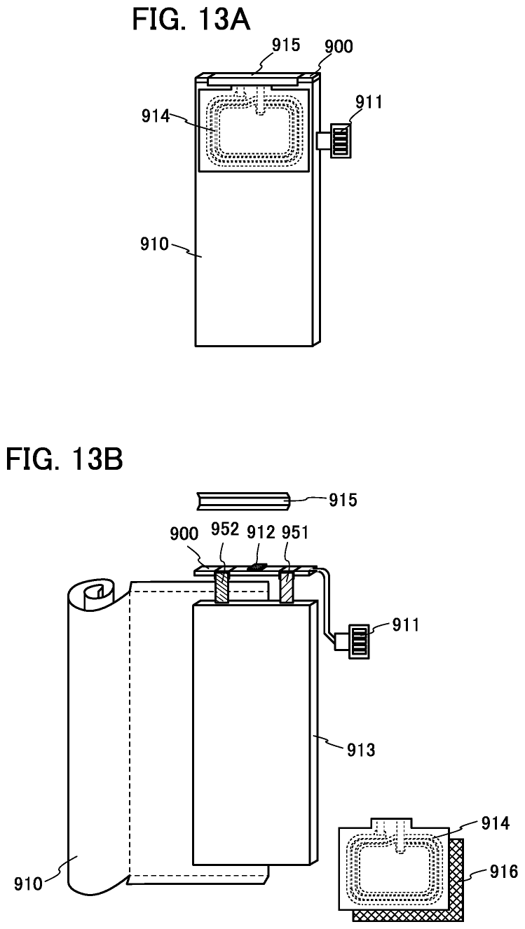

Other structural examples of secondary batteries will be described with reference to FIGS. 13 to 16.

FIG. 13(A) and FIG. 13(B) are external views of a battery pack. The battery pack includes a circuit board 900 and a secondary battery 913. The secondary battery 913 includes a terminal 951 and a terminal 952 and is covered by a label 910. The battery pack may include an antenna 914.

The circuit board 900 is fixed by a sealant 915. The circuit board 900 includes a circuit 912. The terminal 911 is electrically connected to the terminal 951 and the terminal 952 of the secondary battery 913 with the circuit board 900 therebetween. The terminal 911 is electrically connected to the antenna 914 and the circuit 912 with the circuit board 900 therebetween. Note that a plurality of terminals 911 serving as a control signal input terminal, a power supply terminal, and the like may be provided.

For example, the circuit 912 serves as a protective circuit for protecting the secondary battery 913 from overcharge, overdischarge, and overcurrent. The circuit 912 may be provided on the rear surface of the circuit board 900. Note that the shape of the antenna 914 is not limited to a coil shape and may be a linear shape or a plate shape. Further, a planar antenna, an aperture antenna, a traveling-wave antenna, an EH antenna, a magnetic-field antenna, or a dielectric antenna may be used. The antenna 914 has a function of communicating data with an external device, for example. As a system for communication using the antenna 914 between the battery pack and another device, a response method that can be used between the battery pack and another device, such as NFC, can be employed.

The battery pack includes a layer 916 between the secondary battery 913 and the antenna 914. The layer 916 has a function of, for example, preventing an effect of the secondary battery 913 on an electromagnetic field. As the layer 916, for example, a magnetic body can be used.

Note that the structure of the battery pack is not limited to that shown in FIG. 13.

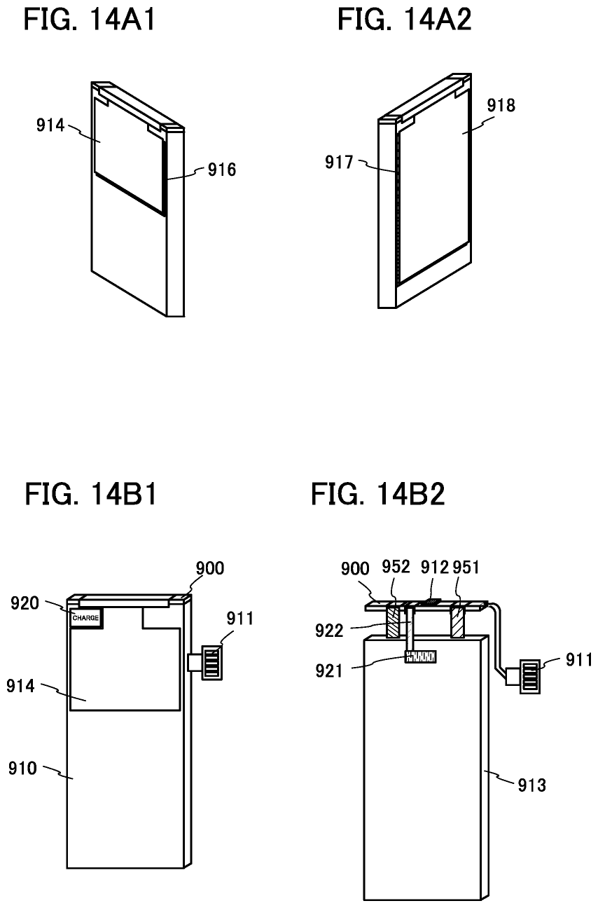

For example, as shown in FIG. 14((A−1) and FIG. 14((A−2), two opposite surfaces of the secondary battery 913 illustrated in FIG. 13(A) and FIG. 13(B) may be provided with an antenna. FIG. 14(A−1) is an external view showing one side of the above pair of surfaces, and FIG. 14(A−2) is an external view showing the other side of the above pair of opposite surfaces. For portions similar to those illustrated in FIG. 13(A) and FIG. 13(B), a description of the battery pack illustrated in FIG. 13(A) and FIG. 13(B) can be referred to as appropriate.

As illustrated in FIG. 14((A−1), the antenna 914 is provided on one of the opposite surfaces of the secondary battery 913 with the layer 916 located therebetween, and as illustrated in FIG. 14((A−2), an antenna 918 is provided on the other of the opposite surfaces of the secondary battery 913 with a layer 917 located therebetween. The layer 917 has a function of, for example, preventing an effect of the secondary battery 913 on an electromagnetic field. As the layer 917, for example, a magnetic body can be used.

With the above structure, the battery pack can have two antennas and both of the antenna 914 and the antenna 918 can be increased in size.

An antenna with a shape that can be applied to the antenna 914 can be used as the antenna 918. The antenna 918 may be a flat-plate conductor. The flat-plate conductor can serve as one of conductors for electric field coupling. That is, the antenna 918 can serve as one of two conductors of a capacitor. Thus, electric power can be transmitted and received not only by an electromagnetic field or a magnetic field but also by an electric field.

Alternatively, as illustrated in FIG. 14((B−1), the battery pack illustrated in FIG. 13(A) and FIG. 13(B) may be provided with a display device 920. The display device 920 is electrically connected to the terminal 911. For portions similar to those illustrated in FIG. 13(A) and FIG. 13(B), a description of the battery pack illustrated in FIG. 13(A) and FIG. 13(B) can be referred to as appropriate.

The display device 920 can display, for example, an image showing whether charging is being carried out, an image showing a remaining capacity, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 14((B−2), the secondary battery 913 illustrated in FIG. 13(A) and FIG. 13(B) may be provided with a sensor 921. The sensor 921 is electrically connected to the terminal 911 via a terminal 922 and the circuit board 900. Note that for portions which are the same as those of the secondary battery 913 illustrated in FIG. 13(A) and FIG. 13(B), a description of the secondary battery 913 illustrated in FIG. 13(A) and FIG. 13(B) can be referred to as appropriate.

The sensor 921 has a function of measuring, for example, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays. With the sensor 921, for example, data on an environment (e.g., temperature) where the secondary battery 913 is placed can be determined and stored in a memory inside the circuit 912.

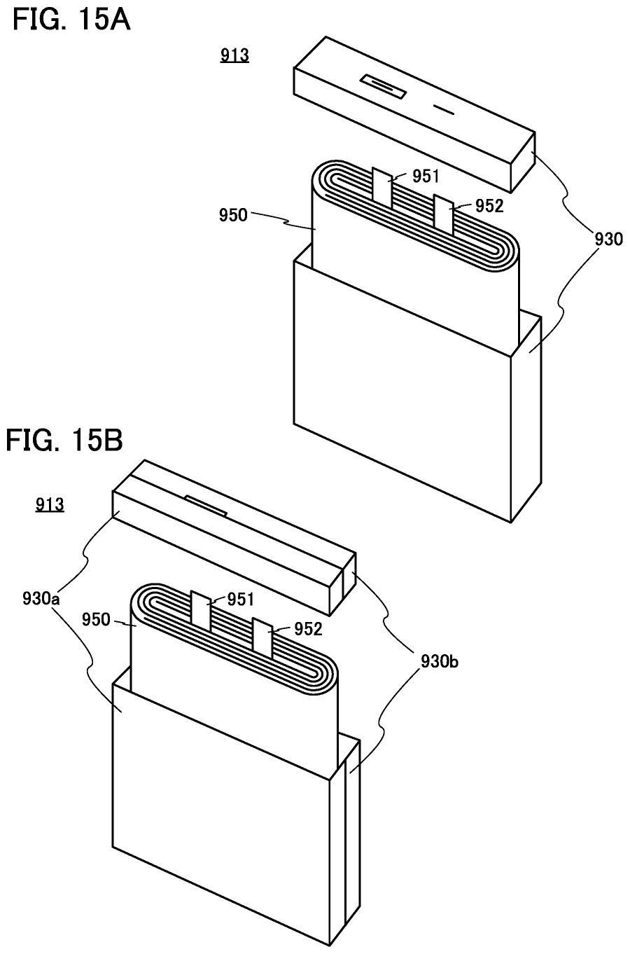

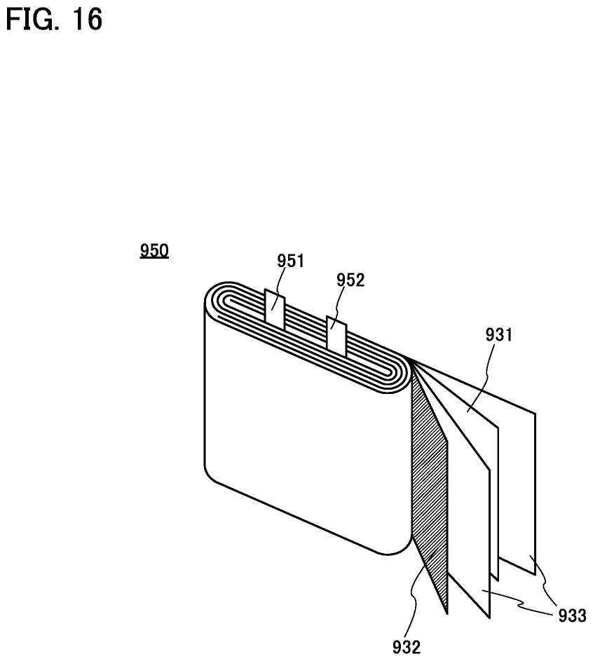

Furthermore, structural examples of the secondary battery 913 will be described with reference to FIG. 15 and FIG. 16.

The secondary battery 913 illustrated in FIG. 15(A) includes a wound body 950 provided with the terminal 951 and the terminal 952 inside a housing 930. The wound body 950 is soaked in an electrolyte solution inside the housing 930. The terminal 952 is in contact with the housing 930. An insulator or the like inhibits contact between the terminal 951 and the housing 930. Note that in FIG. 15(A), the housing 930 divided into two pieces is illustrated for convenience; however, in the actual structure, the wound body 950 is covered with the housing 930 and the terminals 951 and 952 extend to the outside of the housing 930. For the housing 930, a metal material (such as aluminum) or a resin material can be used.

Note that as illustrated in FIG. 15(B), the housing 930 illustrated in FIG. 15(A) may be formed using a plurality of materials. For example, in the secondary battery 913 in FIG. 15(B), a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna such as the antenna 914 may be provided inside the housing 930a. For the housing 930b, a metal material can be used, for example.

FIG. 16 illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks each including the negative electrode 931, the positive electrode 932, and the separator 933 may be stacked.

The negative electrode 931 is connected to the terminal 911 illustrated in FIG. 13 via one of the terminal 951 and the terminal 952. The positive electrode 932 is connected to the terminal 911 in FIG. 13 via the other of the terminal 951 and the terminal 952.

When a microprocessor (including an APS) controlling charging is used in an electronic device, the secondary battery 913 can perform the most suitable charging and have excellent cycle characteristics.

### Embodiment 5

In this embodiment, an example in which a microprocessor controlling charging is mounted on an electronic device is described.

First, examples of an electronic device employing a microprocessor controlling charging include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

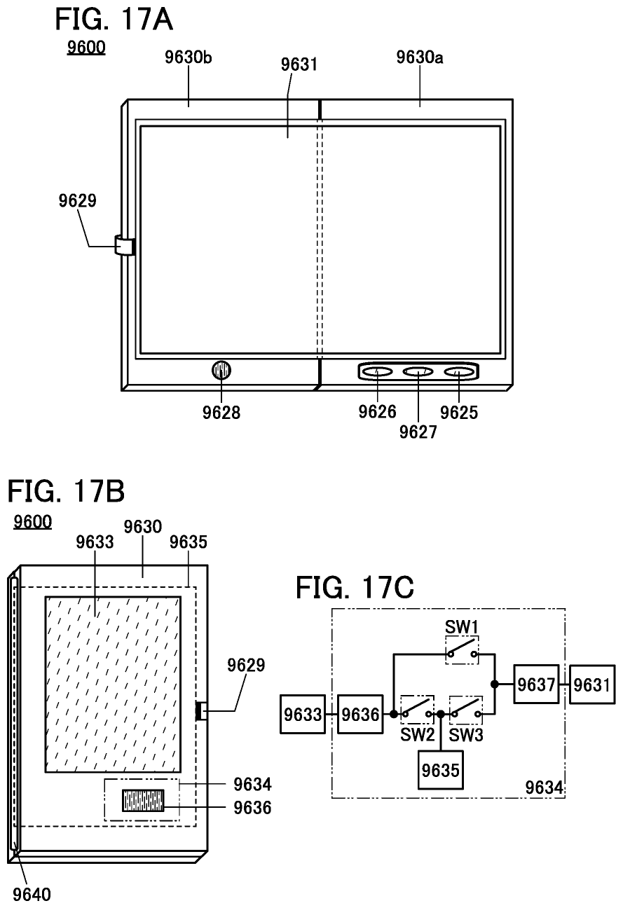

Next, FIG. 17(A) and FIG. 17(B) illustrate an example of a foldable tablet terminal. A tablet terminal 9600 illustrated in FIG. 17(A) and FIG. 17(B) includes a housing 9630a, a housing 9630b, a movable portion 9640 connecting the housing 9630a and the housing 9630b, a display portion 9631, a display mode changing switch 9626, a power switch 9627, a power saving mode changing switch 9625, a fastener 9629, and an operation switch 9628. A flexible panel is used for the display portion 9631, whereby a tablet terminal with a larger display portion can be provided. FIG. 17(A) illustrates the tablet terminal 9600 that is opened, and FIG. 17(B) illustrates the tablet terminal 9600 that is closed.

The tablet terminal 9600 includes a power storage unit 9635 inside the housing 9630a and the housing 9630b. The power storage unit 9635 is provided across the housing 9630a and the housing 9630b, passing through the movable portion 9640.

Part of the display portion 9631 can be a touch panel region and data can be input when a displayed operation key is touched. A switching button for showing/hiding a keyboard of the touch panel is touched with a finger, a stylus, or the like, so that keyboard buttons can be displayed on the display portion 9631.

The display mode switch 9626 can switch the display between a portrait mode and a landscape mode, and between monochrome display and color display, for example. The power saving mode changing switch 9625 can control display luminance in accordance with the amount of external light in use, which is measured with an optical sensor incorporated in the tablet terminal 9600. Another detection device including a sensor for detecting inclination, such as a gyroscope sensor or an acceleration sensor, may be incorporated in the tablet terminal, in addition to the optical sensor.

The tablet terminal is closed in FIG. 17(B). The tablet terminal includes the housing 9630, a solar cell 9633, and a charging and discharging control circuit 9634 including a DC-DC converter 9636. The microprocessor controlling charging according to one embodiment of the present invention and a secondary battery are used as the power storage unit 9635.

The tablet terminal 9600 can be folded such that the housing 9630a and the housing 9630b overlap with each other when not in use. Thus, the display portion 9631 can be protected, which increases the durability of the tablet terminal 9600. The power storage unit 9635 using the microprocessor controlling charging of one embodiment of the present invention is in a full charging state for a reduced time, whereby deterioration of the power storage unit 9635 is reduced and the tablet terminal 9600 that can be used for a long time over a long period can be provided.

The tablet terminal illustrated in FIG. 17(A) and FIG. 17(B) can also have a function of displaying various kinds of information (a still image, a moving image, a text image, and the like), a function of displaying a calendar, a date, the time, or the like on the display portion, a touch-input function of operating or editing data displayed on the display portion by touch input, a function of controlling processing by various kinds of software (programs), and the like.

The solar cell 9633, which is attached on the surface of the tablet terminal, supplies electric power to a touch panel, a display portion, an image signal processor, and the like. Note that the solar cell 9633 can be provided on one or both surfaces of the housing 9630 and the power storage unit 9635 can be charged efficiently.

The structure and operation of the charging and discharging control circuit 9634 illustrated in FIG. 17(B) will be described with reference to a block diagram in FIG. 17(C). The solar cell 9633, the power storage unit 9635, the DC-DC converter 9636, a converter 9637, switches SW1 to SW3, and the display portion 9631 are illustrated in FIG. 17(C), and the power storage unit 9635, the DC-DC converter 9636, the converter 9637, and the switches SW1 to SW3 correspond to the charging and discharging control circuit 9634 in FIG. 17(B).

First, an example of the operation in the case where power is generated by the solar cell 9633 using external light is described. The voltage of electric power generated by the solar cell is raised or lowered by the DC-DC converter 9636 to a voltage for charging the power storage unit 9635. When the power from the solar cell 9633 is used for the operation of the display portion 9631, the switch SW1 is turned on and the voltage of the power is raised or lowered by the converter 9637 to a voltage needed for operating the display portion 9631. When display on the display portion 9631 is not performed, the switch SW1 is turned off and the switch SW2 is turned on, so that the power storage unit 9635 can be charged.

Note that the solar cell 9633 is described as an example of a power generation means: however, one embodiment of the present invention is not limited to this example. The power storage unit 9635 may be charged using another power generation means such as a piezoelectric element or a thermoelectric conversion element (Peltier element). For example, the power storage unit 9635 may be charged with a non-contact power transmission module that transmits and receives power wirelessly (without contact) to charge the battery or with a combination of other charging means.

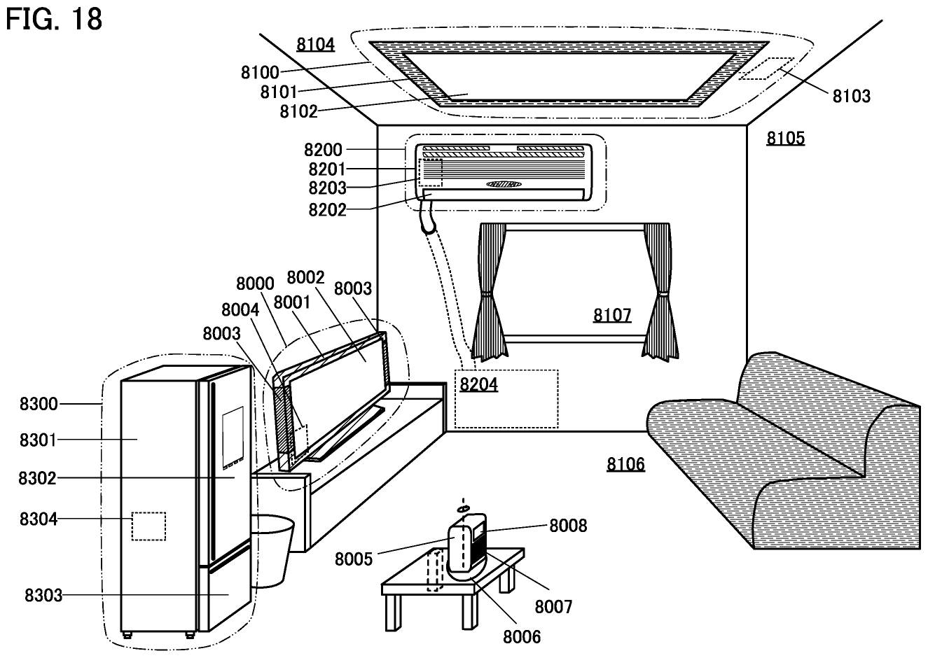

FIG. 18 illustrates other examples of electronic devices. In FIG. 18, a display device 8000 is an example of an electronic device in which charging of a secondary battery 8004 is controlled by a microprocessor. Specifically, the display device 8000 corresponds to a display device for TV broadcast reception and includes a housing 8001, a display portion 8002, speaker portions 8003, the secondary battery 8004, and the like. The microprocessor controlling charging and the secondary battery 8004 according to one embodiment of the present invention are provided in the housing 8001. The display device 8000 can receive electric power from a commercial power supply. Alternatively, the display device 8000 can use electric power stored in the secondary battery 8004.

A semiconductor display device such as a liquid crystal display device, a light-emitting device in which a light-emitting element such as an organic EL element is provided in each pixel, an electrophoretic display device, a digital micromirror device (DMD), a plasma display panel (PDP), or a field emission display (FED) can be used for the display portion 8002.

An audio input device 8005 also uses a secondary battery controlled by a microprocessor controlling charging. The audio input device 8005 includes a speaker 8007, a microphone, and a plurality of sensors (an optical sensor, a temperature sensor, a humidity sensor, a pressure sensor, an illuminance sensor, a motion sensor, and the like) in addition to wireless communication elements. In accordance with an instruction spoken by a user, another device can be operated: for example, powering of the display device 8000 can be controlled, the amount of light of a tabletop lighting device 8100 can be controlled, or the like. The audio input device 8005 is capable of audio operation of a peripheral device and replaces a manual remote controller.

The audio input device 8005 is provided in a stand 8006 which rotates about a shaft indicated by a dotted line and configured to be capable of, while listening to an instruction precisely with the incorporated microphone by rotating in the direction in which speaking by a user can be heard, displaying the content on a display portion 8008 or performing a touch input operation on the display portion 8008.

The audio input device 8005 can also function as a charging doc of a portable information terminal such as a smartphone. With the use of a secondary battery controlled by a microprocessor controlling charging inside the audio input device 8005, the audio input device 8005 can also be referred to as a charging control device. The audio input device 8005 includes a first microprocessor capable of neural net operation performed by audio input or output and a second microprocessor controlling charging. Electric power can be transmitted and received with a wire or wirelessly between the portable information terminal and the audio input device 8005. The portable information terminal is not particularly need to be carried indoors, and a load on the secondary battery and deterioration thereof are desirably avoided while a necessary capacity is ensured. Thus, control or maintenance of the secondary battery or the like is desirably performed by the audio input device 8005. Since the speaker 8007 and the microphone are included, hands-free conversation is possible even during charging.

Although an example in which the stand 8006 is used is illustrated in FIG. 18, the present invention is not particularly limited to the example. The audio input device 8005 may be provided with a wheel or a mechanical transfer means to be transferred to a desired position or may be fixed without providing a stand or a wheel. When the capacity of the secondary battery of the audio input device 8005 decreases, the audio input device 8005 is transferred with the mechanical transfer means and charging is performed by wireless charging from a charging module connected to an external power source.

Note that the display device includes, in its category, all of information display devices for personal computers, advertisement displays, and the like other than TV broadcast reception.

In FIG. 18, the lighting device 8100 is an example of an electronic device using a secondary battery 8103 which is controlled by a microprocessor controlling charging. Specifically, the lighting device 8100 includes a housing 8101, a light source 8102, the secondary battery 8103, and the like. Although FIG. 18 illustrates the case where the secondary battery 8103 is provided in a roof 8104 on which the housing 8101 and the light source 8102 are installed, the secondary battery 8103 may be provided in the housing 8101. The lighting device 8100 can receive electric power from a commercial power supply. Alternatively, the lighting device 8100 can use electric power stored in the secondary battery 8103.

Note that although the tabletop lighting device 8100 provided in the roof 8104 is illustrated in FIG. 18 as an example, the secondary battery controlled by the microprocessor (including an APS) controlling charging can be used as an installation lighting device provided in, for example, a sidewall 8105, a floor 8106, a window 8107, or the like other than the roof 8104. Alternatively, the secondary battery can be used in a tabletop lighting device or the like.

As the light source 8102, an artificial light source which emits light artificially by using power can be used. Specifically, an incandescent lamp, a discharge lamp such as a fluorescent lamp, and a light-emitting element such as an LED or an organic EL element are given as examples of the artificial light source.

In FIG. 18, an air conditioner including an indoor unit 8200 and an outdoor unit 8204 is an example of an electronic device using a secondary battery 8203 which is controlled by a microprocessor controlling charging. Specifically, the indoor unit 8200 includes a housing 8201, an air outlet 8202, the secondary battery 8203, and the like. Although FIG. 18 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can receive electric power from a commercial power supply. Alternatively, the air conditioner can use electric power stored in the secondary battery 8203.

Note that although the split-type air conditioner including the indoor unit and the outdoor unit is illustrated in FIG. 18 as an example, the microprocessor controlling charging can be used in an air conditioner in which the functions of an indoor unit and an outdoor unit are integrated in one housing.

In FIG. 18, an electric refrigerator-freezer 8300 is an example of an electronic device using a secondary battery 8304 which is controlled by a microprocessor controlling charging. Specifically, the electric refrigerator-freezer 8300 includes a housing 8301, a door for refrigerator compartment 8302, a door for freezer compartment 8303, the secondary battery 8304, and the like. The secondary battery 8304 is provided in the housing 8301 in FIG. 18. The electric refrigerator-freezer 8300 can receive electric power from a commercial power supply. Alternatively, the electric refrigerator-freezer 8300 can use electric power stored in the secondary battery 8304.

In addition, in a time period when electronic devices are not used, particularly when the proportion of the amount of power which is actually used to the total amount of power which can be supplied from a commercial power source (such a proportion referred to as a usage rate of power) is low, power can be stored in the secondary battery, whereby an increase in the usage rate of power can be reduced in a time period when the electronic devices are used. For example, in the case of the electric refrigerator-freezer 8300, power can be stored in the secondary battery 8304 in night time when the temperature is low and the door for refrigerator compartment 8302 and the door for freezer compartment 8303 are not often opened and closed. On the other hand, in daytime when the temperature is high and the door for refrigerator compartment 8302 and the door for freezer compartment 8303 are frequently opened and closed, the secondary battery 8304 is used as an auxiliary power source; thus, the usage rate of power in daytime can be reduced.

A secondary battery which is controlled by a microprocessor controlling charging can be provided in any electronic device other than the above-described electronic devices. According to one embodiment of the present invention, the secondary battery can have an excellent lifetime. Thus, the microprocessor controlling charging of one embodiment of the present invention is used in the electronic device described in this embodiment, whereby an electronic device with a longer lifetime can be obtained. This embodiment can be implemented in appropriate combination with any of the other embodiments.

An embodiment described below in this specification includes use of a dedicated computer or a general-purpose computer including a variety of kinds of computer hardware or software. A computer-readable recording medium can be used and mounted on the embodiment described below in this specification. As the recording medium, a RAM, a ROM, an optical disk, a magnetic disk, and other appropriate storage media that can be accessed by a computer may be included. Algorithms, components, flows, programs, and the like shown as examples in the embodiment described below in this specification can be mounted on software or mounted on a combination of hardware and software.

### Embodiment 6

In this embodiment, an example in which a microprocessor controlling charging which is one embodiment of the present invention is provided in a vehicle is described.

The use of secondary batteries in vehicles enables production of next-generation clean energy vehicles such as hybrid electric vehicles (HEVs), electric vehicles (EVs), and plug-in hybrid electric vehicles (PHEVs).

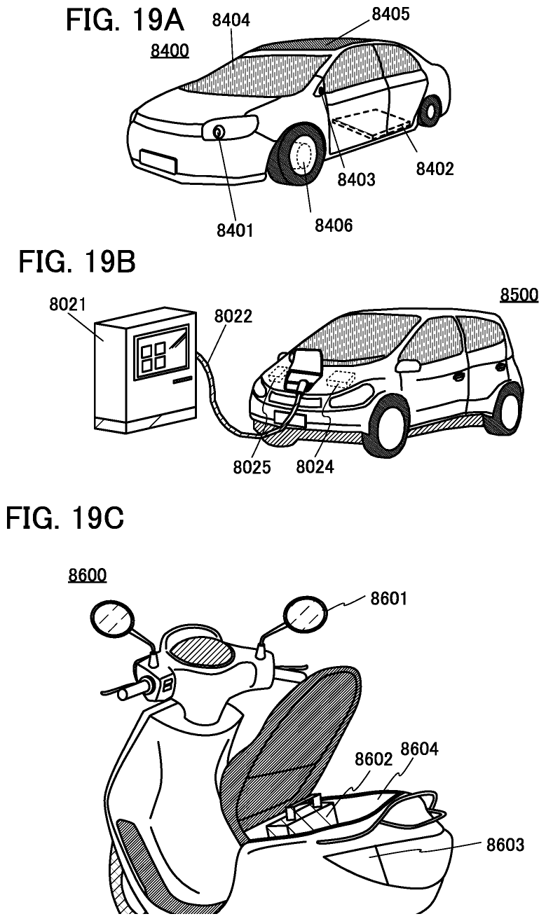

FIG. 19 illustrates an example of a vehicle using the microprocessor controlling charging which is one embodiment of the present invention. An automobile 8400 illustrated in FIG. 19(A) is an electric vehicle that runs on an electric motor as a power source. Alternatively, the automobile 8400 is a hybrid electric vehicle capable of driving appropriately using either an electric motor or an engine. The use of one embodiment of the present invention can achieve a vehicle in which the lifetime of a power storage device is long. The automobile 8400 includes a battery pack 8402. As the battery pack 8402, the small cylindrical secondary batteries illustrated in FIG. 12 are arranged to be used in a floor portion in the automobile. Alternatively, a battery pack in which a plurality of secondary batteries illustrated in FIG. 13 are combined may be placed in the floor portion in the automobile. The battery pack 8402 is used not only for driving an electric motor 8406, but also for supplying electric power to a light-emitting device such as a headlight 8401 or a room light (not illustrated). A roof portion of the automobile 8400 is provided with a photoelectric conversion element 8405, and irradiation light can be photoelectrically converted and stored in the battery pack 8402.

The battery pack 8402 can also supply electric power to a display device of a speedometer, a tachometer, or the like included in the automobile 8400. Furthermore, the battery pack 8402 can supply electric power to a display device included in the automobile 8400, such as a navigation system. A sensor 8403 is included instead of a side mirror and an image obtained by the sensor 8403 may be projected and displayed on part of a windshield 8404. The image obtained by the sensor 8403 may be displayed on the display device in the vehicle.

An automobile 8500 illustrated in FIG. 19(B) can be charged when the secondary battery included in the automobile 8500 is supplied with electric power from external charging equipment by a plug-in system, a contactless power feeding system, or the like. FIG. 19(B) illustrates the state in which the secondary battery 8024 included in the automobile 8500 is charged with a ground-based charging apparatus 8021 through a cable 8022. In charging, a given method such as CHAdeMO (registered trademark) or Combined Charging System may be employed as a charging method, the standard of a connector, or the like as appropriate. The charging apparatus 8021 may be a charging station provided in a commerce facility or a power source in a house. With the use of a plug-in technique, the secondary battery 8024 included in the automobile 8500 can be charged by being supplied with electric power from the outside, for example. The charging can be performed by converting AC electric power into DC electric power through a converter included in the charging apparatus 8021, such as an AC-DC converter. When provided with the AC-DC converter for charging 8025, the automobile 8500 can be charged even when an AC power source is connected.

Furthermore, although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the electric vehicle is stopped but also when driven. In addition, the contactless power feeding system may be utilized to perform transmission and reception of electric power between vehicles. A solar cell may be provided in the exterior of the automobile to charge the secondary battery when the automobile stops or moves. To supply electric power in such a contactless manner, an electromagnetic induction method or a magnetic resonance method can be used.

FIG. 19(C) is an example of a two-wheeled vehicle using a secondary battery controlled by a microprocessor controlling charging. A motor scooter 8600 illustrated in FIG. 19(C) includes a secondary battery 8602, side mirrors 8601, and indicator lights 8603. The secondary battery 8602 can supply electric power to the indicator lights 8603.

Furthermore, in the motor scooter 8600 illustrated in FIG. 19(C), the secondary battery 8602 can be retained in a storage unit under seat 8604. The secondary battery 8602 can be retained in the storage unit under seat 8604 even with a small size. The secondary battery 8602 is detachable; thus, the secondary battery 8602 is carried indoors when charged, and is stored before the motor scooter is driven.

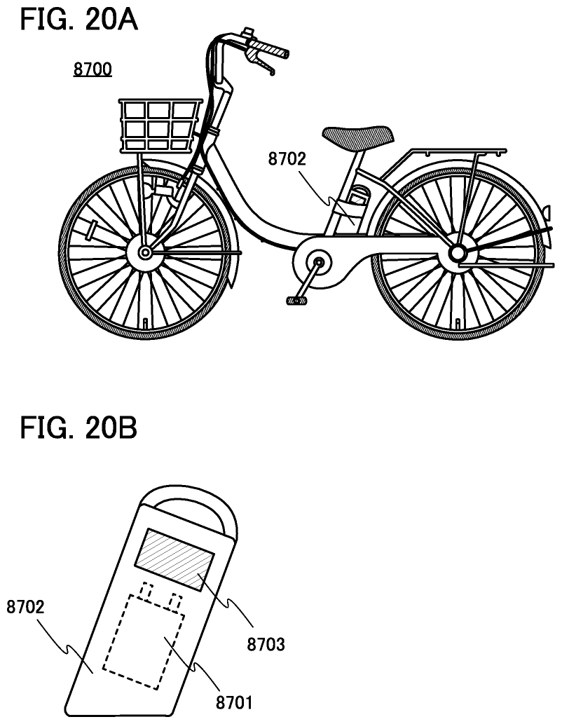

FIG. 20(A) is an example of an electric bicycle using a battery pack including a plurality of secondary batteries controlled by a microprocessor controlling charging. The electric bicycle 8700 illustrated in FIG. 20(A) is provided with a battery pack 8702. The battery pack 8702 can supply electric power to a motor that assists a rider. The battery pack 8702 is portable, and FIG. 20(B) illustrates the state where the battery pack 8702 is detached from the electric bicycle. The battery pack 8702 is equipped with a plurality of laminated secondary batteries 8701 and can display the remaining capacity of the secondary battery and the like on a display portion 8703. In the case where a plurality of secondary batteries are incorporated, the battery pack 8702 includes the above-described charging control device shown in this embodiment and a protective circuit.

According to one embodiment of the present invention, charging is performed by the most suitable charging method owing to the microprocessor controlling charging; accordingly, the lifetime of the incorporated secondary battery can be extended. Furthermore, the secondary battery included in the vehicle can be used as a power source for supplying electric power to products other than the vehicle. In such a case, the use of a commercial power source can be avoided at peak time of electric power demand, for example. If the use of a commercial power source can be avoided at peak time of electric power demand, the avoidance can contribute to energy saving and a reduction in carbon dioxide emissions. Moreover, the lifetime of the secondary battery can be extended and the secondary battery can be used for a long period; thus, the use amount of rare metals such as cobalt can be reduced.

### REFERENCE NUMERALS

600: secondary battery, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 612: safety valve mechanism, 613: conductive plate, 614: conductive plate, 615: module. 616: wiring, 617: temperature control device, 650: portable information terminal, 651: housing, 652: display portion, 660: solar cell, 661: cable, 662: external power source, 663: cable, 670: charging and discharging control circuit, 671: battery, 672: DC-DC converter, 673: converter, 900: circuit board, 910: label, 911: terminal. 912: circuit, 913: secondary battery, 914: antenna, 915: sealant, 916: layer, 917: layer, 918: antenna, 920: display device, 921: sensor, 922: terminal, 930: housing, 930a: housing. 930b: housing, 931: negative electrode, 932: positive electrode, 933: separator, 950: wound body, 951: terminal, 952: terminal, 1100: portable information terminal, 1300: power feeding device, 1311: antenna. 1312: antenna, 8000: display device, 8001: housing, 8002: display portion, 8003: speaker portion, 8004: secondary battery, 8005: audio input device, 8006: stand, 8007: speaker, 8008: display portion, 8021: charging apparatus, 8022: cable, 8024: secondary battery, 8025: AC-DC converter for charging, 8100: lighting device, 8101: housing, 8102: light source, 8103: secondary battery, 8104: roof, 8105: sidewall, 8106: floor, 8107: window, 8200: indoor unit, 8201: housing, 8202: air outlet, 8203: secondary battery, 8204: outdoor unit, 8300: electric refrigerator-freezer, 8301: housing, 8302: door for refrigerator compartment, 8303: door for freezer compartment: door, 8304: secondary battery, 8400: automobile, 8401: headlight, 8402: battery pack, 8403: sensor, 8404: windshield, 8405: photoelectric conversion element, 8406: electric motor, 8500: automobile, 8600: motor scooter, 8601: side mirror, 8602: secondary battery, 8603: indicator light, 8604: storage unit under seat, 8700: electric bicycle, 8701: secondary battery, 8702: battery pack, 8703: display portion, 9600: tablet terminal, 9625: switch, 9626: switch, 9627: power switch, 9628: operation switch, 9629: fastener, 9630: housing, 9630a: housing, 9630b: housing, 9631: display portion, 9633: solar cell, 9634: charging and discharging control circuit. 9635: power storage unit, 9636: DC-DC converter. 9637: converter, 9640: movable portion

1. A charging control system comprising:
a battery portion storing a secondary battery;
a charging and discharging management portion determining a charging plan by neural network computation to reduce a full charging retention time based on the charging plan when a time of connection to an external power source is longer than an estimated charging time for the secondary battery; and
a charging portion comprising a charging retention portion,
wherein at least one of factors used for the neural network computation is a remaining capacity of the secondary battery.

2. The charging control system according to claim 1, wherein the charging and discharging management portion comprises a transistor including an oxide semiconductor.

3. The charging control system according to claim 1, wherein the charging portion is connected to the external power source with a wire.

4. The charging control system according to claim 1, wherein the charging portion comprises an antenna and performs charging and discharging with the external power source wirelessly.

5. The charging control system according to claim 1, comprising a plurality of the secondary batteries.

6. The charging control system according to claim 1, wherein the battery portion is provided in a vehicle.

7. The charging control system according to claim 1, wherein the battery portion is provided in a portable information terminal.

8. The charging control system according to claim 1, wherein communication with a computer is performed and data stored in the computer is used in the neural network computation.

9. The charging control system according to claim 1, wherein the charging and discharging management portion is provided in a portable information terminal.

10. The charging control system according to claim 1, wherein the charging and discharging management portion is provided in a power feeding device.

11. A charging control device comprising:
a power feeding device;
a charging and discharging control circuit electrically connected to the power feeding device;
a microprocessor capable of performing at least neural network computation; and
a communication means instructing or stopping transmission from the power feeding device.

12. The charging control device according to claim 11, wherein the power feeding device comprises a first antenna,
wherein the communication means instructs or stops transmission from the power feeding device to a second antenna overlapping with the first antenna, and
wherein the second antenna is electrically connected to a secondary battery.

13. The charging control device according to claim 11, wherein the power feeding device comprises a memory portion electrically connected to the microprocessor.
